(19) United States
(12) Patent Application Publication
(10) Pub. No.: US 2026/0347103 A1
(43) Pub. Date: Nov. 5, 2026

(54) STORAGE AND RETRIEVAL SYSTEM AND METHOD

(71) Applicant: Ocado Innovation Limited, Hatfield, Hertfordshire (GB)

(72) Inventors: Paul WESTWOOD, Hatfield (GB); Pranav JADVA, Hatfield (GB); Christopher GRAY, Hatfield (GB)

(21) Appl. No.: 19/707,426

(22) Filed: Jun. 15, 2026

Related U.S. Application Data
(63) Continuation of application No. PCT/EP2024/087724, filed on Dec. 19, 2024.

(30) Foreign Application Priority Data
Dec. 20, 2023 (GB) 2319579.5

(51) Int. Cl. B65G 1/04

(52) U.S. Cl. CPC B65G 1/0464; B65G 1/0485

(57) ABSTRACT

A grid interface assembly for receiving one or more containers from a storage and retrieval system including a grid, a plurality of containers located in stacks beneath the grid; and a plurality of load devices operable to move along the grid and configured to retrieve the one or more containers from the stacks, the grid interface assembly includes: a transfer position for receiving one or more containers from the one or more of the plurality of load handling devices operable on the grid; a conveyor apparatus for conveying the one or more containers beneath the grid, the transfer position being laterally disposed from the conveyor apparatus; a transfer mechanism configured to convey containers between the transfer position and the conveyor apparatus.

### RELATED APPLICATIONS

This application is a continuation application of International Patent Application No. PCT/EP2024/087724 filed 19 Dec. 2024 and entitled “Storage and Retrieval System and Method,” which claims priority to UK Patent Application No. GB2319579.5 filed 20 Dec. 2023 and entitled “Storage and Retrieval System and Method”; the entire contents of both of which applications are incorporated herein by reference.

### FIELD OF THE INVENTION

The disclosure herein relates to automated storage and retrieval systems. More specifically but not exclusively, it relates to a storage and retrieval system using stackable containers stored in a workspace located beneath a grid, where the containers, holding objects, are transported using load handling devices travelling on top of the grid. Furthermore, it relates to a range of variations to the system that enables the efficient exchange of containers between the stacks and any peripherals or external systems.

### BACKGROUND

Some commercial and industrial activities require systems that enable the storage and retrieval of a large number of different products. One known type of system for the storage and retrieval of items in multiple product lines involves arranging storage bins or containers in stacks on top of one another, the stacks being arranged in rows. The storage bins or containers are accessed from above, removing the need for aisles between the rows and allowing more containers to be stored in a given space.

GB2520104A, the contents of which are incorporated herein by reference, describes a system in which stacks of containers are arranged within a frame structure. The containers are accessed by robotic load handling devices operative on tracks located on the top of the frame structure. A system of this type is illustrated schematically in FIGS. 1 to 4 of the accompanying drawings.

The process of adding an item to storage containers is referred to as a decant operation, as inbound items are removed from any shipping containers and/or packaging and decanted into some separate storage means. Storage and retrieval system therefore typically include one or more decant stations at which decant operations are performed, wherein the decant station is arranged to receive storage containers and to enable items to be added to the contents of the storage containers. Then, to fulfil a customer order, one or more storage containers containing outbound items are delivered to a picking station, at which the ordered products are picked out of the containers, e.g. by a manual picker or by a robotic picking device.

In storage and retrieval systems such as those described above, storage containers are typically moved between the stacks and any peripheral devices/inventory handling stations, such as decant stations, picking stations or combined pick and decant station of the systems, by the robotic load handling devices. However, some systems also include conveyor interfaces that transport containers between the frame structure and the peripherals. For example, GB2546601A describes such a storage and retrieval system in which the robotic load handling devices can deposit containers on to conveyor belts that then transfer the containers from the frame structure to a vehicle loading area.

The present invention aims to overcome the problems associated with storage and retrieval systems that include conveyor interfaces between the frame structure and any other part of the system, such as any peripherals, or any external system. In particular, these conveyor interfaces typically have limited throughput, which limits the overall efficiency of the system.

It is against this background that the present invention has been devised.

### SUMMARY OF THE INVENTION

The arrangements described herein provide a scalable and cost effective means for increasing the throughput, and therefore the overall efficiency, of storage and retrieval systems that include conveyor interfaces.

According to a first aspect, there is provided a grid interface assembly for receiving one or more containers from a storage and retrieval system comprising a grid, a plurality of containers located in stacks beneath the grid; and
a plurality of load handling devices operable to move along the grid and configured to retrieve the one or more containers from the stacks, the grid interface assembly comprises:
i) a transfer position for receiving one or more containers from the one or more of the plurality of load handling devices operable on the grid,
ii) a conveyor apparatus for conveying the one or more containers beneath the grid, the transfer position being laterally disposed from the conveyor apparatus;
iii) a transfer mechanism configured to convey containers between the transfer position and the conveyor apparatus.

To transfer a container between the transfer position and the conveyor apparatus, optionally, the transfer mechanism comprises a transfer belt, the transfer belt extends continuously between the transfer position and the conveyor apparatus. Optionally, the transfer mechanism comprises a transfer drive mechanism to drive the transfer belt around a continuous loop. Optionally, the transfer mechanism comprises a plurality of transfer mechanisms, each of the plurality of transfer mechanisms comprising a transfer belt and a transfer drive mechanism configured to drive the transfer belt around a continuous loop. Each of the plurality of transfer mechanisms configured to transfer a container between the conveyor apparatus and a respective transfer position.

Optionally, the grid interface assembly comprises a lifting device or lifting mechanism for raising and lowering a conveyor section of the conveyor apparatus and the transfer belt relative to each other so as to expose the transfer belt above the top of the conveyor section such that, in use, the transfer belt contacts the container and to retract the transfer belt below the top of the conveyor section such that, in use, the container contacts the top of the conveyor section.

Optionally, the lifting device can be configured for raising and lowering a conveyor section of the conveyor apparatus relative to the transfer belt between a lowered position to expose the transfer belt above the top of the conveyor section such that, in use, the transfer belt contacts the container and a raised position to retract the transfer belt below the top of the conveyor section such that, in use, the container contacts the top of the conveyor section. The conveyor section can be a separate conveyor unit and the lifting device can be configured to raise and lower the conveyor unit relative to the transfer belt between the lowered position and the raised position. For example, the conveyor apparatus comprises a plurality of rollers and the transfer belt extending into the conveyor apparatus interdigitate between the plurality of rollers. Thus, lowering the conveyor section relative to the transfer belt to the lowered position exposes the transfer belt above the top of the plurality of rollers such that the transfer belt contacts the container bottom wall and raising the conveyor section relative to the transfer belt retracts the transfer belt below the top of the plurality of rollers such that the plurality of rollers contacts the container bottom wall. This allows the transfer mechanism to transfer a container laterally between the transfer position and the conveyor apparatus in a first transport direction when the conveyor section is in the lower position and to convey the container longitudinally along the conveyor apparatus in a second transport direction when the conveyor section is in the raised position, the second transport direction being substantially perpendicular to the first transport direction.

Optionally, the grid interface assembly further comprises a control system comprising one or more processors and memory storing instructions that when executed by the one or more processors cause the one or more processors to operate the lifting device to:
i) lower the conveyor section to the lowered position for transferring one or more containers between the transfer position and the conveyor apparatus; and
ii) raise the conveyor section to the raised position for conveying one or more containers along the conveyor apparatus in a direction substantially perpendicular to the transport direction of the transfer mechanism.

Instead of the conveyor section of the conveyor apparatus moving in a vertical direction relative to the transfer belt between a lowered position to expose the transfer belt and a raised position to retract the transfer belt, alternatively, the lifting device can be configured to raise the transfer belt relative to the conveyor section to a raised position such that the transfer belt is exposed above the top of the conveyor section and lower the transfer belt to a lowered position to retract the transfer belt below the top of the conveyor section. Thus, the control system can be configured to raise the transfer belt relative to the conveyor apparatus to expose the transfer belt to the container bottom wall and a lowered position to retract the transfer belt below the top of the conveyor apparatus such that the container bottom wall contacts the conveyor apparatus.

Optionally, the transfer position comprises a first transfer position and a second transfer position, the conveyor apparatus comprises a first conveyor apparatus and a second conveyor apparatus, and the transfer mechanism comprises a first transfer mechanism and a second transfer mechanism, the first transfer mechanism being configured to convey containers laterally between the first transfer position and the first conveyor apparatus and the second transfer mechanisms being configured to convey containers laterally between the second transfer position and the second conveyor apparatus. For example, the first transfer position may be configured to receive empty containers from the grid and a load handling device operable on the grid may be configured to pick up containers that have been decanted with one or more items from the second transfer position.

Preferably, the first transfer positions and second transfer positions are exposed to the load handling devices operating on the grid. The grid may define grid spaces, each of the first transfer positions and the second transfer positions may then be exposed beneath a corresponding grid space in order to allow the load handling devices operating on the grid to transfer containers between the load handling devices and each of the first and second transfer positions.

The grid interface assembly may be arranged to allow containers to be transferred in to and/or out of the grid. The first conveyor apparatus may be arranged to convey containers in a first direction and the second conveyor arranged to convey containers in a second direction, the first direction being one of towards the grid and away from the grid and the second direction being the other of towards the grid and away from grid. The first conveyor apparatus may be arranged to convey containers in a first direction and the second conveyor apparatus arranged to convey containers in a second direction, the first direction being one of in to the grid and out from the grid and the second direction being the other of to the grid and out from the grid. Alternatively, the first conveyor apparatus and the second conveyor apparatus may be arranged to convey containers in a direction that is any in to the grid and out from the grid.

The first conveyor apparatus may be vertically separated from the second conveyor apparatus. For example, the first conveyor apparatus may be disposed below or above the second conveyor apparatus. The first transfer positions may be adjacent to the first conveyor apparatus and the second transfer positions adjacent to the second conveyor apparatus. The first transfer positions may be vertically separated from the second transfer positions. The first transfer positions may be disposed on a first side of the first conveyor and the second transfer positions disposed on a second side of the second conveyor, the first side being opposite to the second side.

The first conveyor apparatus and the second conveyor apparatus may be longitudinal and extend out from beneath the grid. The first conveyor apparatus may be arranged to convey containers both longitudinally along the first conveyor apparatus and laterally between the first conveyor apparatus and the first transfer positions, and the second conveyor apparatus arranged to convey containers both longitudinally along the second conveyor apparatus and laterally between the second conveyor apparatus and the second transfer positions.

The grid interface assembly may comprise a conveyor assembly providing both the first conveyor apparatus and the second conveyor apparatus, wherein the first transfer positions are disposed on a first side of the conveyor assembly and the second transfer positions are disposed on a second side of the conveyor assembly, the first side being opposite to the second side. The conveyor assembly may be longitudinal and extend out from beneath the grid.

The first transfer positions may be adjacent to the first conveyor apparatus and the second transfer positions may be above the second conveyor apparatus. The first transfer positions may then be vertically separated from the second transfer positions. The first transfer positions may be disposed adjacent to a side of the first conveyor apparatus and the second transfer positions disposed above the second conveyor apparatus.

The first conveyor apparatus and the second conveyor apparatus may be longitudinal and extend out from beneath the grid. Optionally, the first transfer mechanism may extend into the first conveyor apparatus such that the first conveyor apparatus may be arranged to convey containers both longitudinally along the first conveyor apparatus and laterally between the first conveyor apparatus and the first transfer positions. Likewise, the second transfer mechanism may extend into the second conveyor apparatus such that the second conveyor apparatus may be arranged to convey containers both longitudinally along the second conveyor apparatus and vertically between the second conveyor apparatus and the second transfer positions.

The grid interface assembly may comprise a conveyor assembly providing both the first conveyor apparatus and the second conveyor apparatus, wherein the first transfer position is disposed adjacent to a side of the conveyor assembly and the second transfer position is disposed above the conveyor assembly. The conveyor assembly may be longitudinal and extend out from beneath the grid.

The first conveyor apparatus may be adjacent to the second conveyor apparatus. The first conveyor apparatus and the second conveyor apparatus may be vertically aligned. The first conveyor apparatus may then be parallel with the second conveyor apparatus.

The first transfer position may be adjacent to the first conveyor apparatus and the second transfer position adjacent to the second conveyor apparatus. The first transfer position may then be vertically aligned with the second transfer position. The first transfer position may be disposed on a first side of the first conveyor apparatus and the second transfer position disposed on a second side of the second conveyor apparatus, the first side being opposite to the second side.

The first conveyor apparatus and the second conveyor apparatus may be longitudinal and extend out from beneath the grid. The first conveyor apparatus may be arranged to convey containers both longitudinally along the first conveyor apparatus and laterally between the first conveyor apparatus and the first transfer positions, and the second conveyor apparatus arranged to convey containers both longitudinally along the second conveyor apparatus and laterally between the second conveyor apparatus and the second transfer positions.

The grid interface assembly may comprise a conveyor assembly providing both the first conveyor apparatus and the second conveyor apparatus, wherein the first transfer position is disposed on a first side of the conveyor assembly and the second transfer position is disposed on a second side of the conveyor assembly. The conveyor assembly may be longitudinal and extend out from beneath the grid.

The first transfer position may comprise a first subset that are adjacent to the first conveyor apparatus and a second subset that are above the first conveyor apparatus, and the second transfer positions comprise a first subset that are adjacent to the second conveyor apparatus and a second subset that are above the second conveyor apparatus. The first subset of the first transfer position may be vertically aligned with the first subset of the second transfer position. The first subset of the first transfer position may be vertically separated from the second subset of the first transfer position. The first subset of the second transfer position may be vertically separated from the second subset of the second transfer position. The second subset of the first transfer position may be vertically aligned with the second subset of the second transfer position.

The first subset of the first transfer position may be disposed on a first side of the first conveyor apparatus and the first subset of the second transfer position disposed on a second side of the second conveyor apparatus, the first side being opposite to the second side. The second subset of the first transfer position may be adjacent to the second subset of the second transfer position. The second subset of the first transfer position may be parallel with the second subset of the second transfer position.

The first conveyor apparatus and the second conveyor apparatus may be longitudinal and extend out from beneath the grid. The first conveyor apparatus may be arranged to convey containers both longitudinally along the first conveyor apparatus, laterally between the first conveyor apparatus and the first subset of the first transfer position, and vertically between the first conveyor apparatus and the second subset of the first transfer position. The second conveyor apparatus may be arranged to convey containers both longitudinally along the second conveyor apparatus, laterally between the second conveyor apparatus and the first subset of the second transfer position, and vertically between the second conveyor apparatus and the second subset of the second transfer position.

The first subset of the first transfer position and the second subset of the first transfer position may be alternately distributed along the first conveyor apparatus. The first subset of the second transfer position and the second subset of the second transfer position may be alternately distributed along the second conveyor apparatus. The first subset of the first transfer position and the first subset of the second transfer position may be alternately distributed along opposite sides of a conveyor assembly that provides both the first conveyor apparatus and the second conveyor apparatus. The second subset of the first transfer position and the second subset of the second transfer position may be alternately distributed along a top of a conveyor assembly that provides both the first conveyor apparatus and the second conveyor apparatus.

The grid interface assembly may comprise a conveyor assembly providing both the first conveyor apparatus and the second conveyor apparatus, wherein the first subset of the first transfer position is disposed on a first side of the conveyor assembly and the first subset of the second transfer position is disposed on a second side of the conveyor assembly. The conveyor assembly may be longitudinal and extend out from beneath the grid.

According to a second aspect, there is provided a method of operating a storage and retrieval system comprising a grid, a plurality of containers located in stacks beneath the grid, a grid interface assembly disposed beneath the grid, and a plurality of load handling devices arranged to move along the grid and configured to move the containers between the stacks and grid interface assembly. The method comprises using a first conveyor apparatus of the grid interface assembly to convey containers to or from first transfer positions of the grid interface assembly, and using a second conveyor apparatus of the grid interface assembly to convey containers to or from second first transfer positions of the grid interface assembly, the first transfer positions being horizontally separated from the second transfer positions. The method further comprises transferring containers between the first transfer positions of the grid interface assembly and the load handling devices, and transferring containers between the second transfer positions of the grid interface assembly and the load handling devices.

The containers may be conveyed in a first direction by the first conveyor apparatus and conveyed in a second direction by the second conveyor apparatus, the first direction being one of to the grid and away from the grid and the second direction being the other of to the grid and away from grid. The load handling devices may then collect containers from one of the first transfer positions and the second transfer positions, and to deposit containers at the other of the first transfer positions and the second transfer positions.

The containers may be conveyed in a direction by the first conveyor apparatus and the second conveyor apparatus, the direction being any of to the grid and away from the grid. The load handling devices may then either collect containers from or deposit containers at both the first transfer positions and the second transfer positions.

In each of the above aspects, the storage and retrieval system may further comprise rails or tracks arranged to form the grid and on which the load handling devices are arranged to move. The storage and retrieval system may comprise two substantially perpendicular sets of tracks or rails arranged to form the grid. The storage and retrieval system may comprise a first set of substantially parallel rails or tracks and a second set of substantially parallel rails or tracks extending substantially perpendicularly to the first set in a substantially horizontal plane. The storage and retrieval system may comprise a set of uprights, the uprights supporting the tracks, the uprights and tracks together defining a framework.

In each of the above aspects, the load handling devices may comprise a body mounted on wheels, a first set of wheels being arranged to engage with at least two tracks of the first set of tracks, the second set of wheels being arranged to engage with at least two tracks of the second set of tracks, the first set of wheels being independently moveable and driveable with respect to the second set of wheels such that when in motion only one set of wheels is engaged with the grid at any one time thereby enabling movement of the load handling device along the tracks to any point on the grid by driving only the set of wheels engaged with the tracks, the load handling devices further comprising means for removing or replacing containers from the stacks.

The grid interface assembly of the present disclosure provides numerous uses to move one or more containers between different locations in a warehouse facility. These could between different inventory handling stations or different storage and retrieval systems at remote locations. In all of the different cases, preferably, the present disclosure provides a storage and retrieval system comprising:
a grid;
a plurality of containers located in stacks beneath the grid;
   a grid interface assembly according to the present disclosure disposed beneath the grid; and
a plurality of load handling devices arranged to move along the grid and configured to move the containers between the stacks and grid interface assembly,
wherein the first and second conveyor apparatus are longitudinal and extend out from beneath the grid; and the first transfer position is configured to receive one or more containers from one or more of the plurality of load handling devices operable on the grid and one or more of the plurality of load handling devices operable on the grid is configured to pick up one or more containers from the second transfer position.

For example, in the case of handling one or more of the plurality of containers, the present disclosure provides an inventory handling apparatus comprising an inventory handling station, wherein the first conveyor apparatus is configured to convey one or more containers of the plurality of containers to the inventory handling station and the second conveyor apparatus is configured to return the one or more containers of the plurality of containers from the inventory handling station.

The term “handling” can be construed to cover decanting one or more items into a container and/or picking one or more items from the container. The inventory handling apparatus can be a decant apparatus comprising a decant station or a pick apparatus comprising a pick station. For the purpose of decanting one or more items into a container for storage in the frame structure, optionally, the inventory handling apparatus is a decant apparatus and the inventory handling station is a decant station for decanting one or more items into the one or more containers of the plurality of containers.

Thus, empty or partially empty containers dropped off at the first transfer position is transported to the first conveyor apparatus by the first transfer mechanism where it is subsequently transported to the decant station for one or more items to be decanted into the container (herein defined as decanted container). The decanted container is returned to the grid interface assembly by the second conveyor apparatus where it is subsequently transferred to the second transfer position by the second transfer mechanism to be picked up by a load handling device operable on the grid.

To decant one or more items in a container for storage in the storage and retrieval system, the present disclosure provides a method of decanting one or more items into a container by the storage and retrieval system of the present disclosure, the method comprising the steps of:
i) receiving the container at the first transfer position and transferring the container to the first conveyor apparatus;
ii) conveying the container to the decant station;
iii) decanting the one or more items into the container at the decant station;
iv) conveying the decanted container to the second conveyor apparatus and transferring the decanted container to the second transfer position;
v) instructing a loading handing device operable on the grid to pick up the decanted container from the second transfer position.

The grid interface assembly of the present disclosure is not limited to transporting one or more containers to a decant apparatus. The grid interface assembly can be arranged to convey to and from any type of inventory handling apparatus comprising an inventory handling station including but is not limited to a decant apparatus. For example, the inventory handling apparatus can be a pick apparatus comprising a pick station, in which case, the first conveyor apparatus is configured to convey the one or more containers of the plurality of containers to the pick station and the second conveyor apparatus is configured to return the one or more containers of the plurality of containers from the pick station.

Other uses of the grid interface assembly include distributing one or more containers between different storage and retrieval systems located at different locations in a building. For example, a first storage and retrieval system can be used to store items at a chilled temperature (1 °C to 8 °C) and the second storage and retrieval system can be used items at an ambient temperature. Some items such as grocery items can be stored in both the ambient or chilled environment. The ambient temperature is dependent on the external temperature. The present disclosure provides a warehouse comprising:
i) a first storage and retrieval system at a first location and a second storage and retrieval system at a second location, the second location being remote from the first location, each of the first and second storage and retrieval systems comprising a storage and retrieval system of the present disclosure,
iii) a transport device for transporting one or more containers between the first location and the second location;
wherein the corresponding grid interface assemblies of each of the first and second storage and retrieval systems is configured to convey one or more containers to or from the transport device such that the one or more containers is conveyed between the corresponding grid interface assembly of the first and second storage and retrieval systems for storage in their respective first and second storage and retrieval systems.

By transporting one or more containers between the first location and the second location, the corresponding grid interface assemblies of each of the first and second storage and retrieval systems can be configured to enable one or more containers to be shared between each of the first and second storage and retrieval systems. This has advantages where there is limited storage space in one storage and retrieval system and requires the storage of containers to be shared at different levels in a multi-storey building. Thus, one or more containers can be transported between the different storage and retrieval systems to mitigate congestion in any one of the storage and retrieval systems. The first location can be vertically separate from the second location such that the warehouse defines a multi-storey warehouse comprising a first floor and a second floor (i.e., vertically spaced), and wherein the transport device is a lifting device for transporting the one or more containers between the first floor and the second floor.

The present disclosure provides a method of conveying a container between different locations of a warehouse, the method comprising the steps of:
i) receiving the container at the corresponding first transfer position of the first and retrieval system at the first location and transferring the container to the corresponding first conveyor apparatus of the first storage and retrieval system;
ii) conveying the container by the corresponding first conveyor apparatus of the first storage and retrieval system to the transport device;
iii) transporting the container from the first location to the second location by the transport device;
iv) conveying the container to the corresponding second conveyor apparatus of the second storage and retrieval system and transferring the container to the corresponding second transfer position of the second storage and retrieval system;
v) instructing a loading handing device operable on the grid of the second storage and retrieval system to pick up the container from the corresponding second transfer position.

While for a multi-storey warehouse, the different locations can be different vertically separated floors of a building, the first and second locations can be in different buildings or different rooms in a building.

Other variations and advantages will become apparent from the following description.

### BRIEF DESCRIPTION OF THE DRAWINGS

These and other aspects of the invention will now be described, by way of example only, and with reference to the accompanying drawings, in which:

FIG. 1 is a schematic perspective view of a frame structure for housing a plurality of stacks of bins in a known storage system;

FIG. 2 is a schematic plan view of part of the frame structure of FIG. 1;

FIG. 3a is a schematic perspective view of one form of load handling device for use with the frame structure of FIGS. 1 and 2;

FIG. 3b is a schematic perspective cut away view of the load handling device of FIG. 3a showing a container-receiving recess of the load handling device;

FIG. 3c is a schematic perspective cut away view of the load handling device of FIG. 3a showing a container accommodated within the container-receiving recess of the load handling device;

FIG. 4 is a schematic perspective view of a known storage system comprising a plurality of load handler devices of the type shown in FIG. 3(a), 3(b) and 3(c), installed on the frame structure of FIGS. 1 and 2;

FIG. 5a is a schematic perspective view of a portion of a storage system that comprises a grid interface assembly;

FIG. 5b is a schematic end-on view of the portion of the storage system of FIG. 5a;

FIG. 6a is a schematic end-on view of a grid interface assembly;

FIG. 6b is a schematic perspective view of the grid interface assembly of FIG. 6a;

FIG. 7a is a schematic perspective view of an alternative grid interface assembly;

FIG. 7b is a schematic top-down view of the grid interface assembly of FIG. 7a;

FIG. 8a is a schematic perspective view of a further alternative grid interface assembly;

FIG. 8b is a schematic top-down view of the grid interface assembly of FIG. 8a;

FIG. 9a is a schematic perspective view of a yet further alternative grid interface assembly;

FIG. 9b is a schematic top-down view of the grid interface assembly of FIG. 9a;

FIG. 10a is a schematic perspective view of another alternative grid interface assembly; and

FIG. 10b is a schematic top-down view of the grid interface assembly of FIG. 10a.

FIG. 11 is a schematic perspective view of a transfer mechanism that is configured to move a container laterally from a transfer position and the conveyor apparatus.

FIG. 12 is a schematic drawing showing a cross-sectional view of the interaction between the conveyor apparatus and the transfer belt shown in FIG. 11 between (a) a lowered and; (b) a raised position.

FIG. 13 is an enlarged perspective view of the transfer belt of FIG. 11 forming a continuous endless loop;

FIG. 14 is a schematic perspective view of an example of the use of the grid interface assembly interacting with a decant apparatus.

FIG. 15 is a schematic perspective view of another example of the use of the grid interface assembly to share storge space between the different storage and retrieval systems at different floor levels.

In the figures, like features are denoted by like reference signs where appropriate.

### DETAILED DESCRIPTION

The following embodiments represent preferred examples of how the invention may be practiced, but they are not necessarily the only examples of how this could be achieved. These examples are described in sufficient detail to enable those skilled in the art to practice the invention. Other examples may be utilised and structural changes may be made without departing from the scope of the invention as defined in the appended claims. Moreover, direction references and any other terms having an implied orientation are given by way of example to aid the reader's understanding of the particular examples described herein. They should not be read to be requirements or limitations, particularly as to the position, orientation, or use of the invention unless specifically set forth in the appended claims. Similarly, connection references (e.g., attached, coupled, connected, joined, secured, and the like) are to be construed broadly and may include intermediate members between a connection of elements and relative movement between elements. As such, connection references do not necessarily infer that two elements are directly connected and in fixed relation to each other, unless specifically set forth in the appended claims. Similarly, wording such as “movement in the n-direction” and any comparable wording, where n is one of x, y or z, is intended to mean movement substantially along or parallel to the n-axis, in either direction (i.e., towards the positive end of the n-axis or towards the negative end of the n-axis).

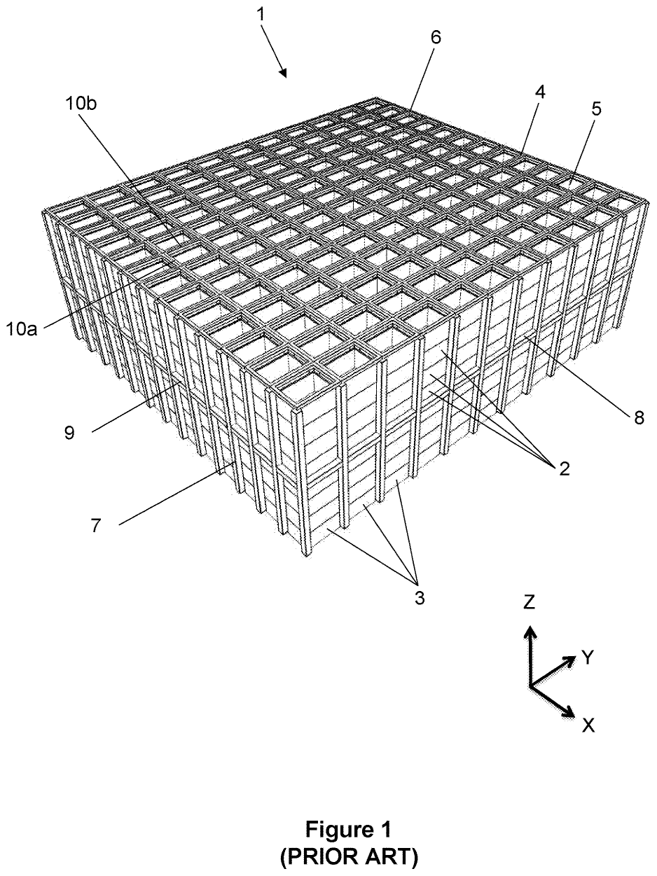

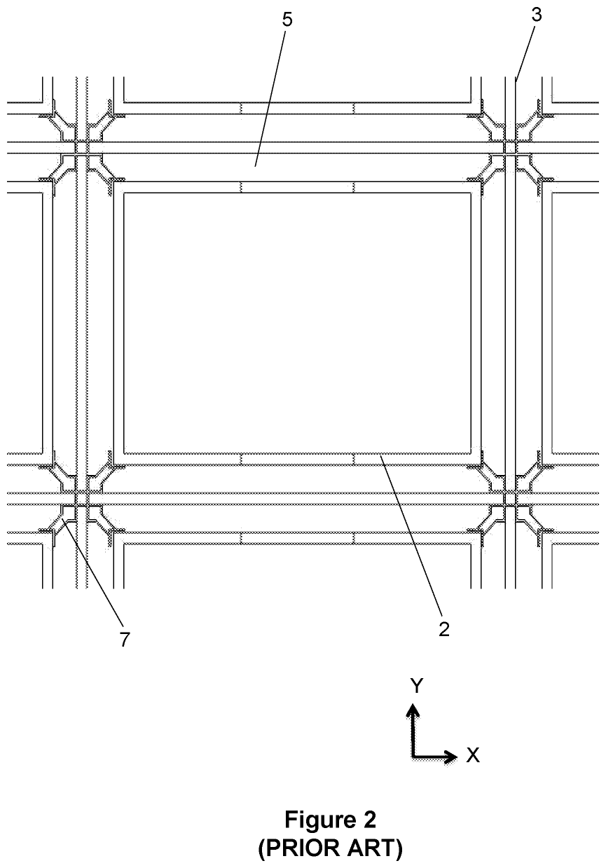

FIG. 1 is a schematic perspective view of a known storage and retrieval system 1 comprising a plurality of stacks 3 of storage containers 2 stored in a workspace located beneath a grid 4, and FIG. 2 is a top-down view showing a single stack 3 of storage containers 2 within the grid 4. As shown in FIG. 1, the stackable storage containers 2, known as bins, are stacked on top of one another to form the stacks 3. The grid 4 defines grid spaces 5 and each stack 3 of containers 2 is disposed beneath and aligned with a grid space 5 such that the containers 2 in a stack 3 can be accessed through a grid space 5. Each storage container 2 typically holds a plurality of product items (not shown), and the product items within a storage container 2 may be identical, or may be of different product types depending on the application.

The grid 4 is part of a frame structure 6 that comprises a plurality of upright members 7 that support horizontal members 8, 9. A first set of parallel horizontal members 8 is arranged perpendicularly to a second set of parallel horizontal members 9 to form a plurality of horizontal grid structures supported by the upright members 7. The members 7, 8, 9 are typically manufactured from metal. The containers 2 are stacked between the members 7, 8, 9 of the frame structure 6, so that the frame structure 6 guards against horizontal movement of the stacks 3 of containers 2, and guides vertical movement of the containers 2.

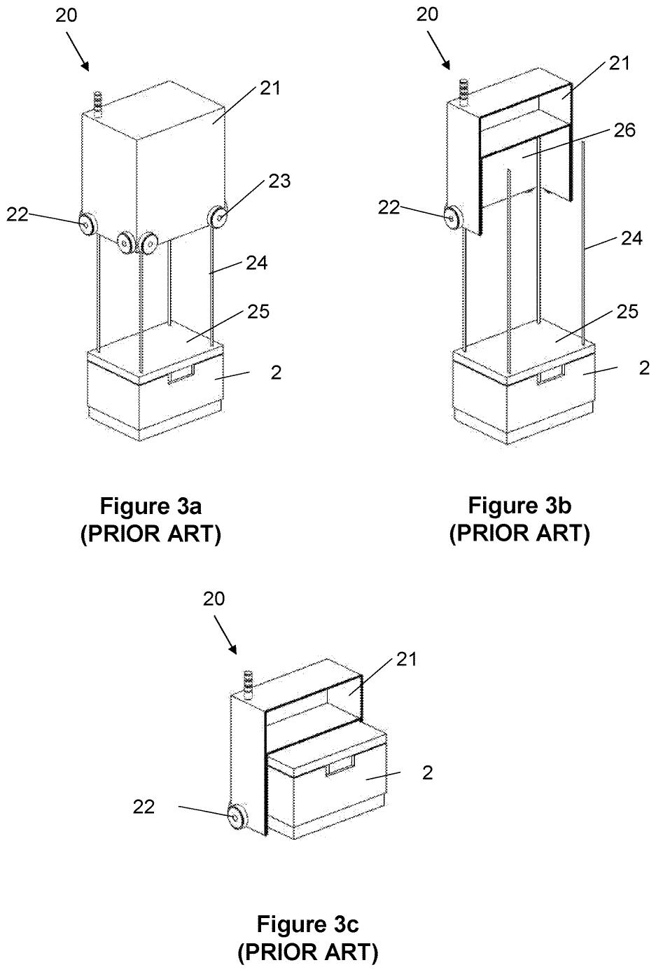

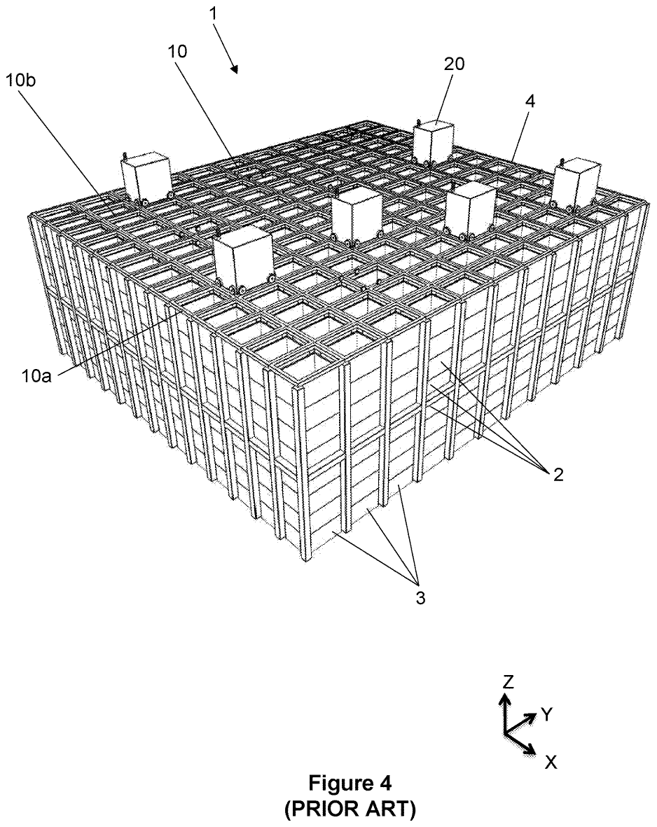

The top level of the frame structure 6 then comprises the grid 4. The grid 4 comprises rails or tracks 10a, 10b supported on the upright members 7 and arranged in a grid pattern above the stacks 3. Referring additionally to FIGS. 3a, 3b, 3c and 4, the tracks 10a, 10b support a plurality of load handling devices 20. A first set of parallel tracks 10a guide movement of the load handling devices 20 in a first direction (X) across the top of the grid 4, and a second set of parallel tracks 10b, arranged perpendicular to the first set 10a, guide movement of the load handling devices 20 in a second direction (Y), perpendicular to the first direction. In this way, the tracks 10a, 10b allow movement of the load handling devices 20 in two dimensions in the X-Y plane, so that a load handling device 20 can be moved into position above any of the stacks 102.

As shown in FIGS. 3a, 3b and 3c, each load handling device 20 comprises a vehicle 21 which is arranged to travel in the X and Y directions on the tracks 10a, 10b of the grid 4, above the stacks 3. A first set of wheels 22, consisting of a pair of wheels 22 on the front of the vehicle 21 and a pair of wheels 22 on the back of the vehicle 21, are arranged to engage with two adjacent tracks of the first set of tracks 10a. Similarly, a second set of wheels 23, consisting of a pair of wheels 23 on each side of the vehicle 21, are arranged to engage with two adjacent tracks of the second set of tracks 10b. Each set of wheels 22, 23 can be lifted and lowered, so that either the first set of wheels 22 or the second set of wheels 23 is engaged with the respective set of tracks 10a, 10b at any one time.

When the first set of wheels 22 is engaged with the first set of tracks 10a and the second set of wheels 23 are lifted clear from the second set of tracks 10b, the first set of wheels 22 can be driven, by way of a drive mechanism (not shown) housed in the vehicle 21, to move the load handling device 20 in the X direction. To move the load handling device 20 in the Y direction, the first set of wheels 22 are lifted clear of the first set of tracks 10a, and the second set of wheels 23 are lowered into engagement with the second set of tracks 10b. The drive mechanism can then be used to drive the second set of wheels 23 to achieve movement in the Y direction. In this way, one or more load handling devices 20 can move around on the grid 4 above the stacks 3 under the control of a central control system (not shown).

FIG. 4 shows a storage system 1 as described above with reference to FIGS. 1 and 2, the system 1 having a plurality of load handling devices 20 active on the grid 4 above the stacks 3. Each load handling device 20 comprises a container-lifting device 24, 25 configured to raise and lower containers 2. In the example illustrated in FIGS. 3a, 3b and 3c, the container-lifting device 24, 25 comprises winch cables or tethers 24 that are arranged to extend in a vertical direction, whose upper ends are attached to the vehicle 21 and whose lower ends are connected to a releasable container-engaging assembly 25. The container-engaging assembly 25 comprises engaging devices (which may, for example, be provided at the corners of the assembly 25) configured to releasably engage with features of the containers 2. For instance, the containers 2 may be provided with one or more apertures in their upper sides with which the engaging devices can engage. Alternatively or additionally, the engaging devices may be configured to hook under rims or lips of the containers 2, and/or to clamp or grasp the containers 2. The cables 24 may be wound up or down to raise or lower the container-engaging assembly 25, as required. One or more motors or other means may be provided to effect or control the winding up or down of the cables 24. The cables 24 and the one or more motors may together form a raising and lowering assembly configured to raise and lower the container-engaging assembly 25.

The wheels 22, 23 are arranged around the periphery of a cavity or recess, known as a container-receiving recess 26, provided by the vehicle 21. The recess is sized to accommodate a container 2 when it is lifted by the container-lifting device 24, 25, as shown in FIG. 3c. When in the recess 26, the container 2 is lifted clear of the tracks 10a, 10b beneath, so that the vehicle 21 can move laterally to a different location. On reaching the target location, for example another stack or an access point in the storage system, the container 2 can be lowered from the container receiving recess 26 and released from the container-lifting device 24, 25. In this way, the each load handling device 20 is able to lift a storage container 2 from beneath the grid 4 of a storage system of the type shown in FIG. 1, and transport the storage container 2 to another location within the system.

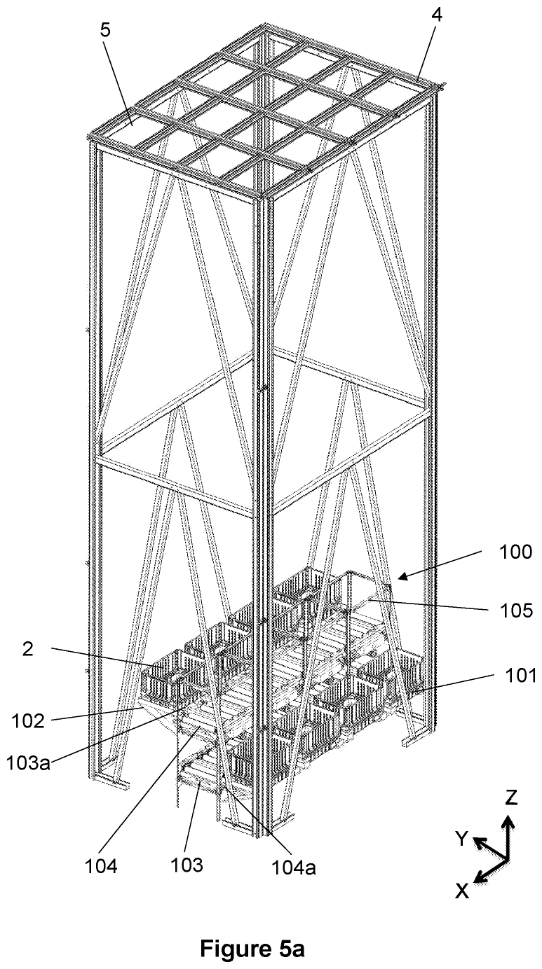

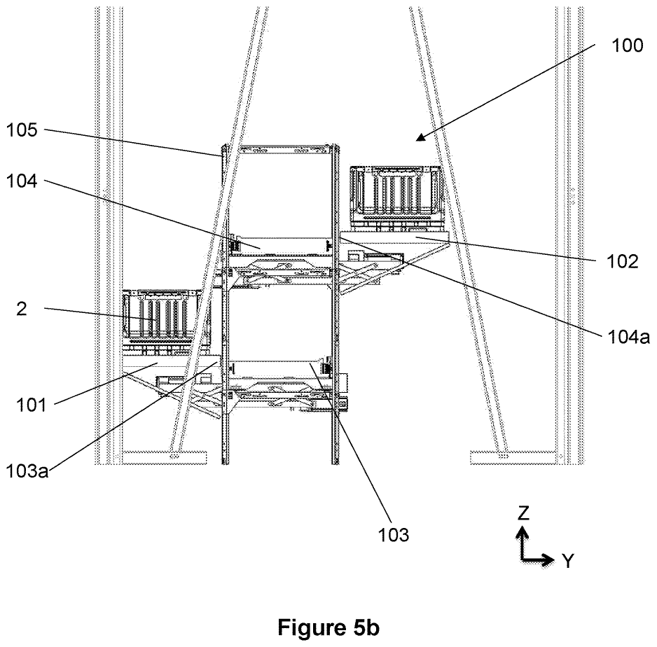

FIGS. 5a and 5b then show an arrangement suitable for use in a storage and retrieval system 1 such as that illustrated in FIGS. 1 and 4 that provides an interface for the transfer of containers 2 in to and out of the grid 4. This arrangement comprises a grid interface assembly 100 at least partially disposed beneath an interface portion 4a of the grid 4, the grid interface assembly 100 being arranged to allow 5 containers to be transferred in to and/or out from the grid. The interface portion 4a is connected to and preferably continuous with a storage portion (not shown) of the grid 4, with the stacks 3 of containers 2 then being located beneath the storage portion.

The grid interface assembly 100 comprises a plurality of first transfer positions 101 and a plurality of second transfer positions 102 at which containers 2 are transferred between the grid interface assembly 100 and the load handling devices 20 operating on the grid 4. The grid interface assembly 100 then further comprises a first conveyor apparatus 103 arranged to convey containers 2 to or from the first transfer positions 101 and a second conveyor apparatus 104 arranged to convey containers 2 to or from the second transfer positions 104. In the arrangement shown in FIGS. 5a and 5b, the first conveyor apparatus 103 and the second conveyor apparatus 104 are longitudinal and extend out from beneath the grid 4.

The first conveyor apparatus 103 and the second conveyor apparatus 104 are arranged to provide an interface between the transfer positions 101, 102 and a sub-system or system that is external to the workspace (i.e. that is not beneath the grid 4). For example, the first conveyor apparatus 103 and the second conveyor apparatus 104 may be arranged to provide an interface to one or more peripherals, such as pick stations, decant stations, etc. or any other parts of the system, such as loading areas or separate grids that form part of the system 1. To do so, the first conveyor apparatus 103 and the second conveyor apparatus 104 may be connected to external conveyors that convey containers towards and away from the grid 4.

The first transfer positions 101 are horizontally separated from the second transfer positions 102 such that both the first transfer positions 101 and the second transfer positions 102 are separately exposed to the load handling devices 20 operating on the grid 4. As described above, the grid 4 defines grid spaces 5 and the load handling devices 20 are configured to raise and lower containers 2 through the grid spaces 5. Each of the first transfer positions 101 and the second transfer positions 102 are therefore exposed beneath a corresponding grid space 5 in order to allow the load handling devices 20 operating on the grid 4 to transfer containers 2 between the load handling devices 20 and each of the first and second transfer positions 101, 102.

In the arrangement shown in FIGS. 5a and 5b, the first conveyor apparatus 103 is vertically separated from the second conveyor apparatus 104 (i.e. they are disposed at different heights). In particular, the first conveyor apparatus 103 is disposed below the second conveyor apparatus 104. The first transfer positions 101 are then adjacent to the first conveyor apparatus 103 and the second transfer positions 102 are adjacent to the second conveyor apparatus 104. Specifically, the first transfer positions 101 are disposed on a first side 103a of the first conveyor apparatus 103 and the second transfer positions 102 are disposed on a second side 104a of the second conveyor apparatus 104, the first side 103a being opposite to the second side 104a. Consequently, the first transfer positions 101 are both horizontally and vertically separated from the second transfer positions 102.

The first conveyor apparatus 103 is then arranged to convey containers 2 both longitudinally (i.e. in the X direction) along the first conveyor apparatus 103 and laterally (i.e. in the Y direction) between the first conveyor apparatus 103 and the first transfer positions 101, and the second conveyor apparatus 104 is arranged to convey containers 2 both longitudinally along the second conveyor apparatus 104 and laterally between the second conveyor apparatus 104 and the second transfer positions 102.

In the arrangement shown in FIGS. 5a and 5b, the first conveyor apparatus 103 is horizontally aligned with the second conveyor apparatus 104 and the transfer positions 101, 102 are immediately adjacent to the corresponding conveyor apparatus 103, 104 in order to minimise the space consumed beneath the grid 4. This is particularly advantageous when the space available beneath the grid 4 is limited. The vertical separation between the first conveyor apparatus 103 and the second conveyor apparatus 104 is then sufficient to allow a container 2 to move along the first conveyor apparatus 103 without being obstructed by the second conveyor apparatus 104 but with minimal additional separation. This arrangement therefore also minimises the distance that containers have to be conveyed in order to move in to or out of the transfer positions, which minimises the transfer time.

In particular, in the arrangement shown in FIGS. 5a and 5b, the grid interface assembly 100 comprises a conveyor assembly 105 providing both the first conveyor apparatus 103 and the second conveyor apparatus 104. The first transfer positions 101 are disposed on a first side of the conveyor assembly 105 and the second transfer positions 102 are disposed on a second side of the conveyor assembly 105, the first side of the conveyor assembly 105 being opposite to the second side of the conveyor assembly 105.

The grid interface assembly 100 is arranged to allow containers 2 to be transferred in to and/or out from the grid 4. In particular, the grid interface assembly 100 may be arranged to either transfer containers 2 in to the grid 4, transfer containers 2 out from the grid 4, or transfer containers 2 both in to and out from the grid 4.

In order to only transfer containers 2 in to the grid 4, both the first conveyor apparatus 103 and the second conveyor apparatus 104 would be arranged to convey containers towards the grid 4. For example, the both the first conveyor apparatus 103 and the second conveyor apparatus 104 could be arranged to convey containers 2 both longitudinally towards the grid 4 and laterally in to the first and second transfer positions 101, 102 respectively. In such an arrangement, the grid interface assembly 100 is used to convey ingoing containers 2 in to the grid 4, such that the first and second transfer positions 101, 102 function as inward transfer positions. The system 1 then uses the load handling devices 20 to collect the incoming containers 2 from the transfer positions 101, 102 provided by the grid interface assembly 100.

Conversely, in order to only transfer containers 2 out from the grid 4, both the first conveyor apparatus 103 and the second conveyor apparatus 104 would be arranged to convey containers away from the grid 4. For example, both the first conveyor apparatus 103 and the second conveyor apparatus 104 could be arranged to convey containers 2 both laterally out from the first and second transfer positions 101, 102 respectively and longitudinally away the grid 4. In such an arrangement, the grid interface assembly 100 is used to convey outgoing containers 2 out from the grid 4, such that the first and second transfer positions 101, 102 would then function as outward transfer positions. The system 1 then uses the load handling devices 20 to deposit the outgoing containers 2 into the transfer positions 101, 102 provided by the grid interface assembly 100.

In order to transfer containers 2 both in to and out from the grid 4, one of the first conveyor apparatus 103 and the second conveyor apparatus 104 could be arranged to transfer containers 2 in to the grid 4 while the other of the first conveyor apparatus 103 and the second conveyor apparatus 104 could be arranged to transfer containers 2 out from the grid 4. For example, the first conveyor apparatus 103 could be arranged to convey containers 2 longitudinally towards the grid 4 and then laterally in to the first transfer positions 101 and the second conveyor apparatus 104 could be arranged to convey containers 2 laterally out from the second transfer positions 102 and then longitudinally away the grid 4. In such an arrangement, the grid interface assembly 100 is used to both convey ingoing containers 2 in to the grid 4, with the first transfer positions 101 functioning as inward transfer positions, and to convey outgoing containers 2 out from the grid 4, with the second transfer positions 102 functioning as outward transfer positions. The system 1 then uses the load handling devices 20 to collect incoming containers 2 from the first transfer positions 101 and to deposit outgoing containers 2 at the second transfer positions 102.

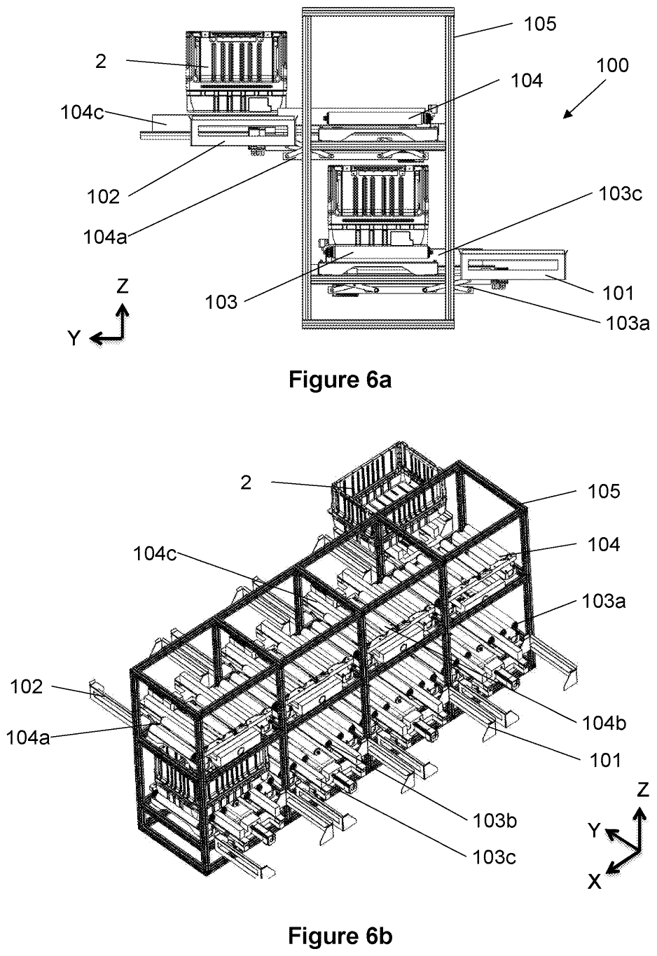

FIGS. 6a and 6b show an optional arrangement of a grid interface assembly 100 suitable for use in a storage and retrieval system 1 such as that illustrated in FIGS. 1 and 4. In this arrangement, the first transfer positions 101 are each provided by a pair of support members that extend laterally away from a first side 103a of the first conveyor 103, each pair of support members being arranged to support a container 2. The second transfer positions 102 are then each provided by a pair of support members that extend laterally away from a second side 104a of the second conveyor 104, the first side 103a being opposite to the second side 104a such that the support members extend in opposing directions. The first conveyor 103 and the second conveyor 104 then each comprise a plurality of independently controlled conveyor sections, with a separate conveyor section for each of the first and second transfer positions 101, 102.

In the arrangement shown in FIGS. 6a and 6b, each conveyor section comprises a conveyor unit 103b, 104b that is arranged to convey containers longitudinally and a transfer mechanism 103c, 104c that is arranged to convey containers laterally between the conveyor 103, 104 and the corresponding transfer position 101, 102. In particular, in the arrangement shown in FIGS. 6a and 6b, each conveyor unit 103 b, 104 b comprises a section of roller conveyor and each of the transfer mechanisms 103c, 104c comprises a pop-up transfer shuttle that rises up from beneath the roller conveyor in order to lift a container 2 resting on the roller conveyor, then moves laterally in order to convey the container 2 into the corresponding transfer position 101, 102, before descending until the container 2 is supported in the transfer position 101, 102. In an alternative arrangement, each conveyor unit 103b, 104b could comprise belt conveyors, chain conveyors etc., and each transfer mechanism 103c, 104c could comprise any of pop-up rollers, belts, chains, wheels, or forks. In a yet further alternative arrangement, each conveyor section could comprise an omni wheel conveyor, in which powered omni wheels having different orientations are arranged in an array such that containers 2 can be conveyed in multiple directions.

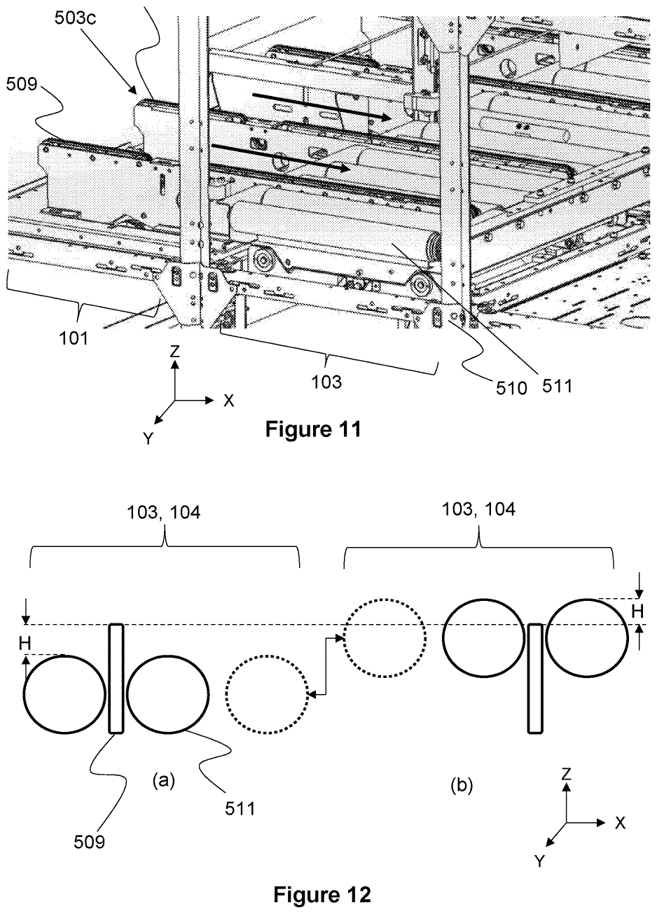

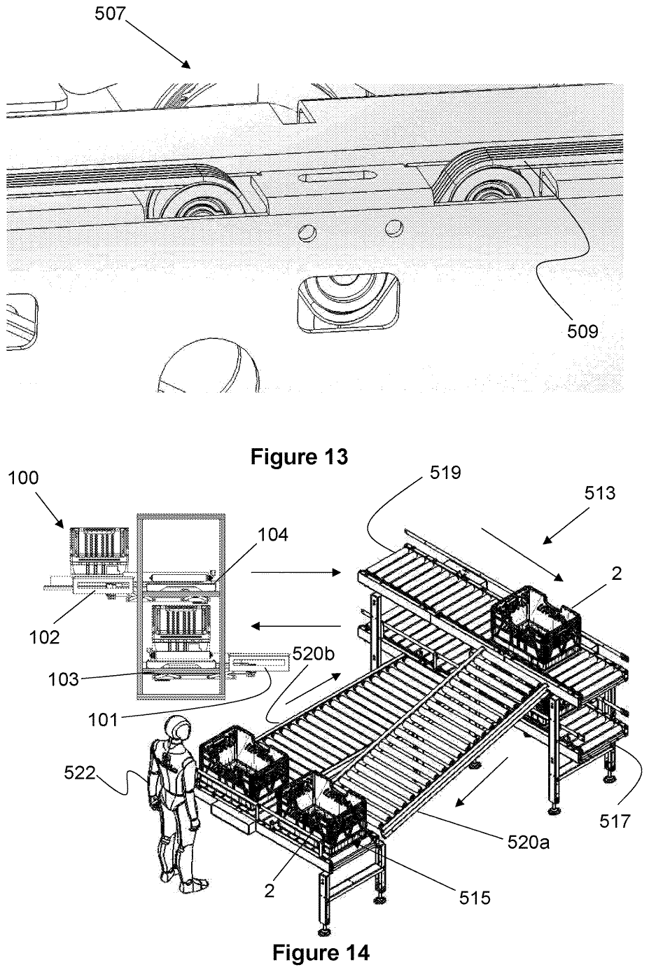

The transfer mechanism 103c, 104c shown in FIGS. 6a and 6b is configured to transfer the container 2 laterally across one or more cells of the grid interface assembly, each of the one or more cells corresponding to the width and/or length of the container 2. In a particular example of the transfer mechanism 503c shown in FIG. 11 and a schematic cross-sectional view of the transfer mechanism shown in FIG. 12(a and b), the transfer mechanism 503c comprises at least one transfer belt 509 that extends continuously between the conveyor 103, 104 and the corresponding transfer positions 101, 102, i.e., extends continuously in a direction substantially perpendicular to the conveying direction of the first and/or second conveyors 103, 104 and substantially across two cells (shown by the arrows in FIG. 11). For the purpose of the present invention, the term “continuously” is construed to providing a continuous surface that extends across the transfer position and the conveyor or a belt that continuously extends across the conveyor and the corresponding transfer position. In the particular example shown in FIG. 13, the transfer belt of the transfer mechanism is in the form a continuous loop extending between the transfer position and the conveyor.

The transfer mechanism 503c is shown in FIG. 11 fixedly coupled a frame 510 at the transfer position 101, 102 such that the at least transfer belt 509 extends continuously into the conveyor 103, 104. By having a transfer belt that extends continuously between the conveyor 103, 104 and the corresponding transfer position 101, 102 removes the need to have a separate pop-up transfer for the transfer mechanism and therefore, simplifies the transfer mechanism. Typically, a pop-up transfer comprises a plurality of rollers and one or more belts interdigitated between the plurality of rollers. To transfer the container 2 in a lateral direction to the conveyor 103, 104, there is relative movement in a vertical direction between the plurality of rollers and the one or more belts of the pop-up transfer. As a result, separate motors are required for the relative movement in a vertical direction between the plurality of rollers and the one or more belts and for separately rotating the plurality of rollers. In addition, to having separate motors for driving the pop-up transfer, a separate motor is required to drive the conveyor units 103, 104 to move the containers in a longitudinal direction along the conveyor. As a result, an excessive number of motors are required to convey containers longitudinally and laterally between the conveyor 103, 104 and the corresponding transfer positions 101, 102.

In the present disclosure, the at least one transfer belt 509 extends continuously between the conveyor 103, 104 and the corresponding transfer position 101, 102 to form a continuous loop (see FIG. 13). This reduces the number of motors required to convey containers longitudinally and laterally between the conveyor 103, 104 and the corresponding transfer position 101, 102. Thus, instead of having a pop-up transfer to move the container laterally between the conveyor 103, 104 and the corresponding transfer position 101, 102, the conveyor 103, 104 comprises a pop-up conveyor, whereby the conveyor unit or conveyor section is moveable in a vertical direction relative to the at least one transfer belt. As shown in FIG. 11, the at least one transfer belt extends continuously from the transfer position 101, 102 to the conveyor 103, 104 such that the at least one transfer belt 509 interdigitate between the rollers 511 of the conveyor 103, 104. To transfer the container laterally between the conveyor 103, 104 and the corresponding transfer positions 101, 102, the conveyor 103, 104 moves in a vertical direction relative to the at least one transfer belt between a lowered position to expose the at least one transfer belt to contact the container bottom wall as shown in FIG. 12(a) (i.e. above the top surface of the rollers of the conveyor 103, 104) and a raised position to retract the at least one transfer belt to expose the rollers of the conveyor 103, 104 to contact the container bottom wall as shown in FIG. 12(b). In other words, the at least one transfer belt extending across the conveyor and the corresponding transfer position is fixed in the vertical direction and the conveyor moves in a vertical direction between the lowered position and raised position relative to the at least one transfer belt to move the container 2 laterally between the conveyor 103, 104 and the corresponding transfer position 101, 102. A drive mechanism drives the transfer belt 509 to move in a continuous loop (herein defined as a transfer drive mechanism). The displacement, H, of the conveyor 103, 104 between the lowered and raised position can range between 5 mm and 10 mm.

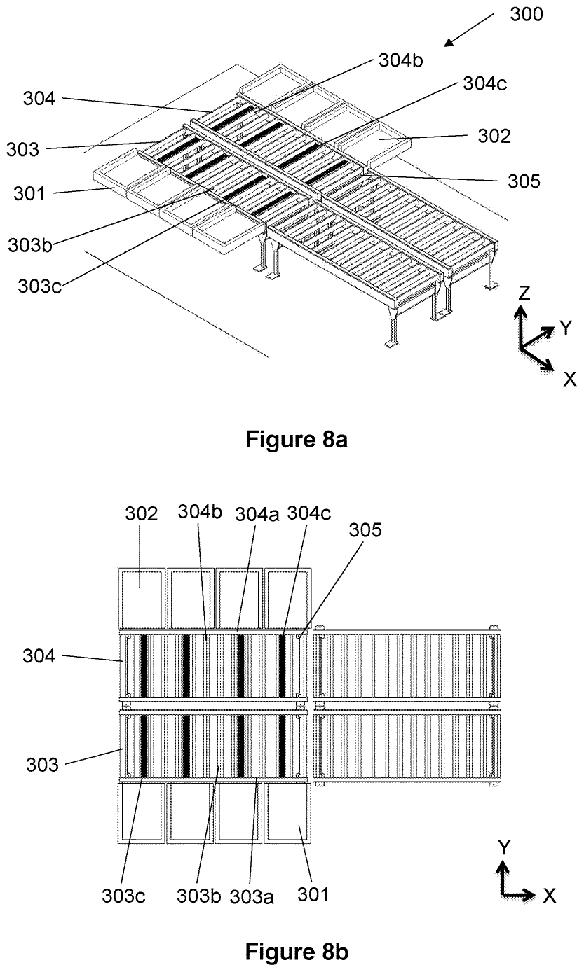

In contrast to the pop-up transfer discussed above, the number of motors required to convey containers both longitudinally and laterally between the conveyor 103, 104 and the corresponding transfer position 101, 102 is substantially reduced. For example, the grid interface assembly can comprise a first motor to drive the at least one transfer belt around a continuous loop, a second motor to drive the plurality of rollers of the conveyor to move a container in a longitudinal direction along the conveyor and a third motor to move the conveyor in a vertical direction relative to the at least one transfer belt. A plurality of first transfer belts 509 are shown in FIG. 11 spaced part along a first side of the first conveyor 103 to support the container 2 bottom wall, each of the plurality of first transfer belts extend continuously across the first conveyor 103 and the corresponding first transfer positions 101. Similarly, a plurality of second transfer belts are spaced apart along a second side of the second conveyor 104, each of the plurality of the second transfer belts extend continuously across the second conveyor 103, 104 and the corresponding second transfer positions 101, 102; the second side of the second conveyor being opposite the first side of the first conveyor. Containers are conveyed inwardly into the grid via the first transfer positions and outwardly out of the grid via the second transfer positions. The present disclosure is not limited to the plurality of second transfer belts being spaced apart along the second side of the second conveyor 104. The plurality of second transfer belts can be spaced apart along the second side of the first conveyor 103, i.e., along the same conveyor. The first conveyor can be vertically separated from the second conveyor as shown in FIG. 6(a and b) or adjacent the second conveyor as shown in FIG. 8(a and b).

Instead of the conveyor moving in a vertical direction between lowered and raised positions to transfer a container laterally between the transfer position and the conveyor, the transfer mechanism itself can comprise a lifting mechanism to move the transfer belt in a vertical direction between a lowered position and a raised position relative to the conveyor. Thus, to move the container laterally between the transfer position and the conveyor, the lifting mechanism raises the transfer belt relative to the conveyor to a raised position to expose the transfer belt above the top of the conveyor and a lowered position to retract the transfer belt below the top of the conveyor. In both cases, the number of motors to convey containers longitudinally and laterally between the conveyor 103, 104 and the corresponding transfer position 101, 102 is reduced.

A control system (not shown) can be configured to control the movement of the transfer belt and the conveyor relative to each other to convey containers both longitudinally and laterally between the conveyor 103, 104 and the corresponding transfer position 101, 102. For example, when transferring a container laterally between the transfer position and the conveyor, the control system is operable to actuate the lifting mechanism to lower the conveyor unit or conveyor section to the lowered position so as to expose the transfer belt above the top of the conveyor unit as shown in FIG. 12(a). Once in the lowered position, the control system actuates a drive mechanism to drive the transfer belt and move the container laterally from the transfer position to the conveyor. To move the container longitudinally along the conveyor, the conveyor is raised to the raised position as shown in FIG. 12(b) so that the conveyor contacts the bottom wall of the container.

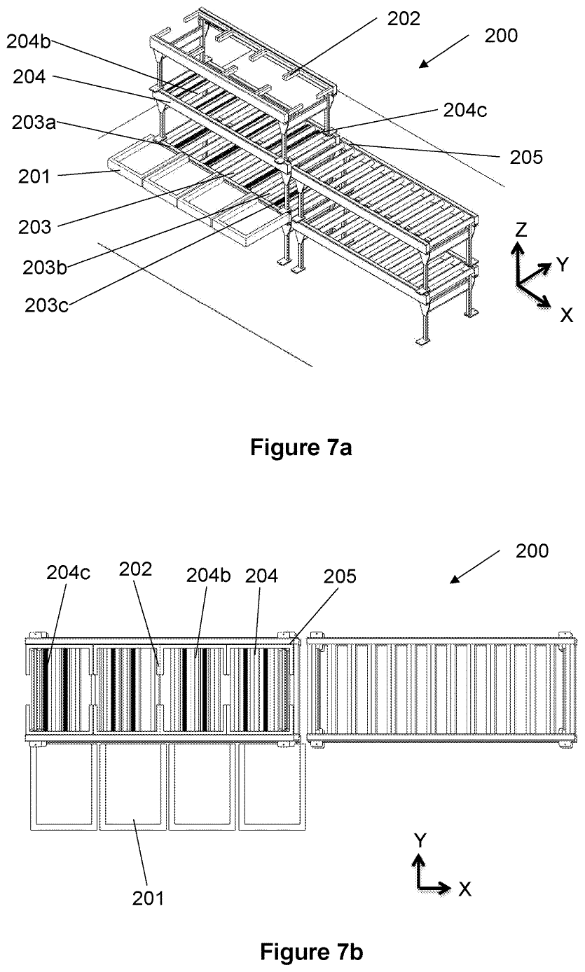

FIGS. 7a and 7b show an alternative arrangement of a grid interface assembly 200 suitable for use in a storage and retrieval system 1 such as that illustrated in FIGS. 1 and 4. The grid interface assembly 200 of FIGS. 7a and 7b is substantially similar to that of FIGS. 5a, 5b, 6a and 6b and corresponding reference numerals have therefore been used for like or corresponding parts or features. However, in contrast with the grid interface assembly 100 of FIGS. 5a to 6b, in the grid interface assembly 200 of FIGS. 7a and 7b the second transfer positions 202 are above the second conveyor apparatus 204 (rather than adjacent to the second conveyor apparatus 204). Consequently, the first transfer positions 201 are both horizontally and vertically separated from the second transfer positions 202.

The first conveyor apparatus 203 is then arranged to convey containers 2 both longitudinally (i.e. in the X direction) along the first conveyor apparatus 203 and laterally (i.e. in the Y direction) between the first conveyor apparatus 203 and the first transfer positions 201, and the second conveyor apparatus 204 is arranged to convey containers 2 both longitudinally (i.e. in the X direction) along the second conveyor apparatus 204 and vertically (i.e. in the Z direction) between the second conveyor apparatus 204 and the second transfer positions 202.

In the arrangement shown in FIGS. 7a and 7b, the grid interface assembly 200 comprises a conveyor assembly 205 providing both the first conveyor apparatus 203 and the second conveyor apparatus 204. The first transfer positions 201 are then disposed on a side of the conveyor assembly 205 while the second transfer positions 202 are above the conveyor assembly 205.

In the arrangement shown in FIGS. 7a and 7b, each of the first transfer positions 101 is provided by a shelf that extends laterally away from a side 203a of the first conveyor apparatus 203, the shelf being arranged to support a container 2. The second transfer positions 202 are then each provided by retractable supports disposed above a corresponding portion of the second conveyor apparatus 204, the retractable supports being arranged to move between an extended position in which they can support a container and a retracted position in which a container 2 can be moved vertically passed the retractable supports. The first conveyor apparatus 203 and the second conveyor apparatus 204 then each comprise a plurality of independently controlled conveyor sections, with a separate conveyor section for each of the first and second transfer positions 201, 202.

In the arrangement shown in FIGS. 7a and 7b, each conveyor section comprises a conveyor unit 203b, 204b that is arranged to convey containers longitudinally and a transfer mechanism 203c, 204c that is arranged to convey containers between the conveyor apparatus 203, 204 and the corresponding transfer position 201, 202. In particular, in the arrangement shown in FIGS. 7a and 7b, each conveyor unit 203 b, 204 b comprises a section of roller conveyor. Each of the transfer mechanisms 203c of the first conveyor apparatus 203 then comprise a pop-up transfer belt that rises up from beneath the corresponding roller conveyor in order to lift a container 2 resting on the roller conveyor, rotates in order to convey a container 2 laterally into the corresponding first transfer position 201, before descending until the container 2 is supported in the first transfer position 201. Each of the transfer mechanisms 204c of the second conveyor 204 then comprise a pop-up transfer lift that rises up from beneath the corresponding roller conveyor in order to lift a container 2 resting on the roller conveyor and convey the container 2 vertically until the container 2 is above the retracted supports of the second transfer position 202. The supports of the second transfer position 202 then extend before the lift descends such that the container 2 is then supported in the second transfer position 202 (on the extended supports).

The grid interface assembly 200 is arranged to allow containers 2 to be transferred in to and/or out from the grid 4. In particular, the grid interface assembly 200 may be arranged to either transfer containers 2 in to the grid 4, transfer containers 2 out from the grid, or transfer containers 2 both in to and out from the grid 4. In the latter case, one of the first conveyor apparatus 203 and the second conveyor apparatus 204 would be arranged to transfer containers 2 in to the grid 4 while the other of the first conveyor apparatus 203 and the second conveyor apparatus 204 would be arranged to transfer containers 2 out from the grid 4.

FIGS. 8a and 8b show a further alternative arrangement of a grid interface assembly 300 suitable for use in a storage and retrieval system 1 such as that illustrated in FIGS. 1 and 4. The grid interface assembly 300 of FIGS. 7a and 7b is substantially similar to that of FIGS. 5a, 5b, 6a and 6b and corresponding reference numerals have therefore been used for like or corresponding parts or features. However, in contrast with the grid interface assembly 100 of FIGS. 5a to 6b, in the grid interface assembly 300 of FIGS. 8a and 8b the first conveyor apparatus 303 is vertically aligned with the second conveyor apparatus 304 (i.e. they are disposed at the same height). In particular, the first conveyor apparatus 303 is disposed adjacent to the second conveyor apparatus 304. The first transfer positions 301 are then adjacent to the first conveyor apparatus 303 and the second transfer positions 302 are adjacent to the second conveyor apparatus 304. Specifically, the first transfer positions 301 are disposed on a first side 303a of the first conveyor apparatus 303 and the second transfer positions 302 are disposed on a second side 304a of the second conveyor apparatus 304, the first side 303a being opposite to the second side 304a. Consequently, the first transfer positions 301 are vertically aligned with the second transfer positions 302 (i.e. they are disposed at the same height).

The first conveyor apparatus 303 is then arranged to convey containers 2 both longitudinally (i.e. in the X direction) along the first conveyor apparatus 303 and laterally (i.e. in the Y direction) between the first conveyor apparatus 303 and the first transfer positions 301, and the second conveyor apparatus 304 is arranged to convey containers 2 both longitudinally (i.e. in the X direction) along the second conveyor apparatus 304 and laterally (i.e. in the Y direction) between the second conveyor apparatus 304 and the second transfer positions 302.

In the arrangement shown in FIGS. 8a and 8b, the grid interface assembly 300 comprises a conveyor assembly 305 providing both the first conveyor apparatus 303 and the second conveyor apparatus 304. The first transfer positions 301 are disposed on a first side of the conveyor assembly 305 and the second transfer positions 302 are disposed on a second side of the conveyor assembly 305, the first lateral side of the conveyor assembly 305 being opposite to the second lateral side of the conveyor assembly 305.

In the arrangement shown in FIGS. 8a and 8b, the first transfer positions 301 are each provided by a shelf that extends laterally away from a first side 303a of the first conveyor apparatus 303, the shelf being arranged to support a container 2. The second transfer positions 302 are then each provided by a shelf that extends laterally away from a second side 304a of the second conveyor apparatus 304, the first side 303a being opposite to the second side 304a such that the shelves extend in opposing directions. The first conveyor apparatus 303 and the second conveyor apparatus 304 then each comprise a plurality of independently controlled conveyor sections, with a separate conveyor section for each of the first and second transfer positions 301, 302. In the arrangement shown in FIGS. 8a and 8b, each conveyor section then comprises a conveyor unit 303b, 304b that is arranged to convey containers longitudinally and a transfer mechanism 303c, 304c that is arranged to convey containers laterally between the conveyor 303, 304 and the corresponding transfer position 301, 302. In particular, in the arrangement shown in FIGS. 8a and 8b, each conveyor unit 303b, 304b comprises a section of roller conveyor. Each of the transfer mechanisms 303c, 304c then comprise a pop-up transfer belt that rises up from beneath the roller conveyor in order to lift a container 2 resting on the roller conveyor, rotates in order to convey a container 2 laterally into the corresponding transfer position 301, 302, before descending until the container 2 is supported in the transfer position 301, 302.

The grid interface assembly 300 is arranged to allow containers 2 to be transferred in to and/or out from the grid 4. In particular, the grid interface assembly 300 may be arranged to either transfer containers 2 in to the grid 4, transfer containers 2 out from the grid, or transfer containers 2 both in to and out from the grid 4. In the latter case, one of the first conveyor apparatus 303 and the second conveyor apparatus 304 would be arranged to transfer containers 2 in to the grid 4 while the other of the first conveyor apparatus 303 and the second conveyor apparatus 304 would be arranged to transfer containers 2 out from the grid 4.

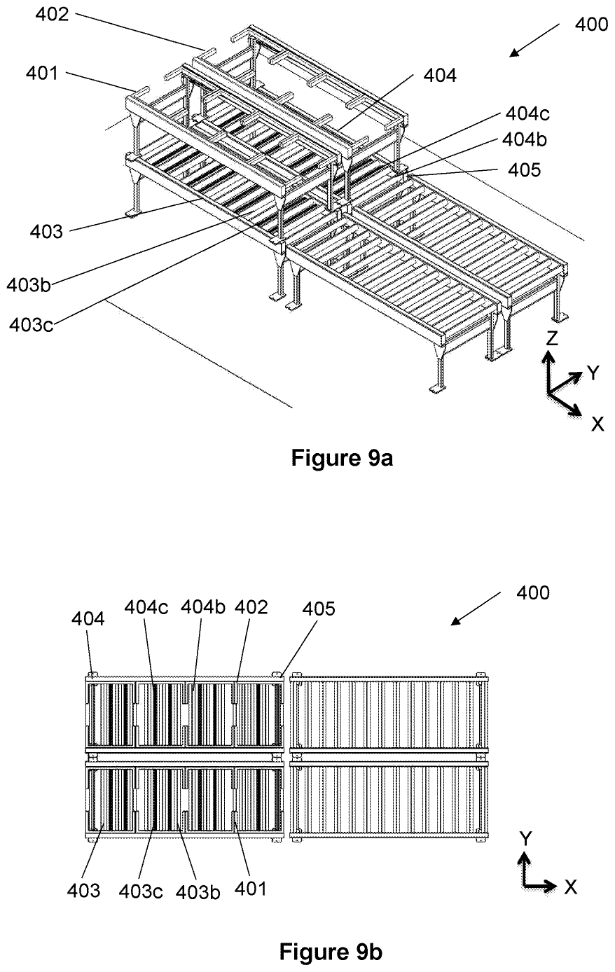

FIGS. 9a and 9b show a yet further alternative arrangement of a grid interface assembly 400 suitable for use in a storage and retrieval system 1 such as that illustrated in FIGS. 1 and 4. The grid interface assembly 400 of FIGS. 9a and 9b is substantially similar to that of FIGS. 8a and 8b and corresponding reference numerals have therefore been used for like or corresponding parts or features. However, in contrast with the grid interface assembly 300 of FIGS. 8a and 8b, in the grid interface assembly 400 of FIGS. 9a and 9b the first transfer positions 401 are above the first conveyor apparatus 403 and the second transfer positions 402 are above the second conveyor apparatus 404.

The first conveyor apparatus 403 is then arranged to convey containers 2 both longitudinally (i.e. in the X direction) along the first conveyor apparatus 403 and vertically (i.e. in the Z direction) between the first conveyor apparatus 403 and the first transfer positions 401, and the second conveyor apparatus 404 is arranged to convey containers 2 both longitudinally (i.e. in the X direction) along the second conveyor apparatus 404 and vertically (i.e. in the Z direction) between the second conveyor apparatus 404 and the second transfer positions 402.

In the arrangement shown in FIGS. 9a and 9b, the grid interface assembly 400 comprises a conveyor assembly 405 providing both the first conveyor apparatus 403 and the second apparatus conveyor 404, with the first conveyor apparatus 403 being disposed adjacent to the second conveyor apparatus 404. The first transfer positions 401 and the second transfer positions 402 are therefore disposed above the conveyor assembly 405, directly over the corresponding conveyor apparatus 403, 404, and are therefore adjacent to one another. The first transfer positions 401 are therefore vertically aligned with the second transfer positions 402 (i.e. they are disposed at the same height).

In the arrangement shown in FIGS. 9a and 9b, each of the first transfer positions 401 is provided by retractable supports disposed above a corresponding portion of the first conveyor apparatus 403, and each of the second transfer positions 202 is provided by retractable supports disposed above a corresponding portion of the second conveyor apparatus 204, the retractable supports being arranged to move between an extended position in which they can support a container 2 and a retracted position in which a container 2 can be moved vertically passed the retractable supports. The first conveyor apparatus 403 and the second conveyor apparatus 404 then each comprise a plurality of independently controlled conveyor sections, with a separate conveyor section for each of the first and second transfer positions 401, 402.

In the arrangement shown in FIGS. 9a and 9b, each conveyor section then comprises a conveyor unit 403b, 404b that is arranged to convey containers longitudinally and a transfer mechanism 403c, 404c that is arranged to convey containers vertically between the conveyor apparatus 403, 404 and the corresponding transfer position 401, 402. In particular, in the arrangement shown in FIGS. 9a and 9b, each conveyor unit 403b, 404b comprises a section of roller conveyor. Each of the transfer mechanisms 403c, 404c then comprise a pop-up transfer lift that rises up from beneath the corresponding roller conveyor in order to lift a container 2 resting on the roller conveyor and convey the container 2 vertically until the container 2 is above the retracted supports of the corresponding transfer position 401, 402. The supports of the corresponding transfer position 401, 402 then extend before the lift descends such that the container 2 is then supported in the transfer position 401, 402 (on the extended supports).

The grid interface assembly 400 is arranged to allow containers 2 to be transferred in to and/or out from the grid 4. In particular, the grid interface assembly 400 may be arranged to either transfer containers 2 in to the grid 4, transfer containers 2 out from the grid, or transfer containers 2 both in to and out from the grid 4. In the latter case, one of the first conveyor apparatus 403 and the second conveyor apparatus 404 would be arranged to transfer containers 2 in to the grid 4 while the other of the first conveyor apparatus 403 and the second conveyor apparatus 404 would be arranged to transfer containers 2 out from the grid 4.

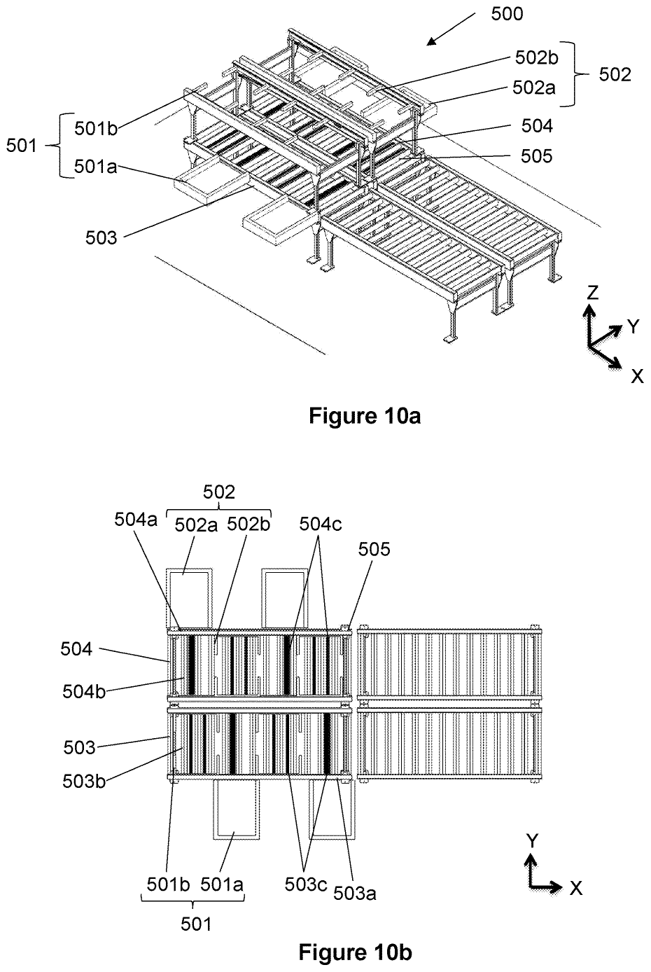

FIGS. 10a and 10b show another alternative arrangement of a grid interface assembly 500 suitable for use in a storage and retrieval system 1 such as that illustrated in FIGS. 1 and 4. The grid interface assembly 500 of FIGS. 10a and 10b is substantially similar to that of FIGS. 8a and 8b and corresponding reference numerals have therefore been used for like or corresponding parts or features. However, in contrast with the grid interface assembly 300 of FIGS. 8a and 8b, in the grid interface assembly 500 of FIGS. 10a and 10b both the first transfer positions 501 and the second transfer positions 502 are arranged as first and second subsets, with the first subset 501a, 502a being disposed adjacent to the corresponding conveyor apparatus 503, 504 and the second subset 501b, 502b being disposed above the corresponding conveyor apparatus 503, 504. In particular, the first subset 501a of the first transfer positions 501 are adjacent to the first conveyor apparatus 503 and the second subset 501b of the first transfer positions 501 are above the first conveyor apparatus 503. The first subset 502a of the second transfer positions 502 are adjacent to the second conveyor apparatus 504 and the second subset 502b of the second transfer positions 502 are above the second conveyor apparatus 504.

The first conveyor apparatus 503 is then arranged to convey containers 2 longitudinally (i.e. in the X direction) along the first conveyor apparatus 503, laterally (i.e. in the Y direction) between the first conveyor apparatus 503 and the first subset 501a of the first transfer positions 501, and vertically (i.e. in the Z direction) between the first conveyor apparatus 503 and the second subset 501b of the first transfer positions 501. The second conveyor apparatus 504 is then also arranged to convey containers 2 longitudinally (i.e. in the X direction) along the second conveyor apparatus 504, laterally (i.e. in the Y direction) between the second conveyor apparatus 504 and the first subset 502a of the second transfer positions 502, and vertically (i.e. in the Z direction) between the second conveyor apparatus 504 and the second subset 502b of the second transfer positions 502.

In the arrangement shown in FIGS. 10a and 10b, the first subset 501a of the first transfer positions 501 are each provided by a shelf that extends laterally away from a first side 503a of the first conveyor apparatus 503, the shelf being arranged to support a container 2. The first subset 502a of the second transfer positions 502 are also each provided by a shelf that extends laterally away from a second side 504a of the second conveyor apparatus 504, the first side 503a being opposite to the second side 504a such that the shelves extend in opposing directions. The second subset 501b of the first transfer positions 501 are then each provided by retractable supports disposed above a corresponding portion of the first conveyor apparatus 503, the retractable supports being arranged to move between an extended position in which they can support a container 2 and a retracted position in which a container 2 can be moved vertically passed the retractable supports. The second subset 502b of the second transfer positions 502 are also each provided by retractable supports disposed above a corresponding portion of the second conveyor apparatus 503.

The first conveyor apparatus 503 and the second conveyor apparatus 504 then each comprise a plurality of independently controlled conveyor sections, with a separate conveyor section for each of the first and second transfer positions 501, 502. In the arrangement shown in FIGS. 10a and 10b, each conveyor section then comprises a conveyor unit 503b, 504b that is arranged to convey containers longitudinally and a transfer mechanism 503c, 504c that is arranged to convey containers between the conveyor 503, 504 and the corresponding transfer position 501, 502. In particular, in the arrangement shown in FIGS. 10a and 10b, each conveyor unit 503b, 504b comprises a section of roller conveyor. The transfer mechanisms 503c, 504c associated with each transfer position of the first subsets 501b, 502b comprises a pop-up transfer belt that rises up from beneath the roller conveyor in order to lift a container 2 resting on the roller conveyor, rotates in order to convey a container 2 laterally into the corresponding transfer position 501a, 502a, before descending until the container 2 is supported in the transfer position 501a, 502a. The transfer mechanisms 503c, 504c associated with each transfer position of the second subsets 501b, 502b comprises a pop-up transfer lift that rises up from beneath the roller conveyor in order to lift a container 2 resting on the roller conveyor and convey the container 2 vertically until the container 2 is above the retracted supports of the corresponding transfer position 501b, 502b. The supports of the corresponding transfer position 501b, 502b then extend before the lift descends such that the container 2 is then supported in the transfer position 501b, 502b (on the extended supports).

The grid interface assembly discussed above offers numerous uses to transfer containers between the frame structure and any peripherals, or any external system. In one example, the grid interface assembly of the present disclosure can be used to transfer containers between the frame structure and an inventory handling apparatus comprising an inventory handling station for handling one or more containers of the plurality of containers. The inventory handling apparatus can be a decant apparatus comprising a decant station or a pick apparatus comprising a pick station. In the particular example, the grid interface assembly of the present disclosure can be used to transfer containers between the frame structure and a decant station for decanting one or more items into the containers. FIG. 14 shows a decant apparatus 513 comprising a decant station 515 and a separate conveyor system that respectively couples with the first and second conveyor apparatuses 103, 104 of the grid interface assembly 100 to transfer decanted containers into the frame structure. In the particular example shown in FIG. 14, one or more containers 2 is conveyed between the decant station 515 and the grid interface assembly 100 of FIG. 6(a and b). However, the present disclosure is not limited to the grid interface assembly shown in FIG. 6(a and b) and can be any type of the grid interface assemblies discussed above.

To differentiate from the first and second conveyor apparatuses 103, 104 of the grid interface assembly 100, the separate conveyor system of the decant apparatus can be termed third and fourth conveyor apparatuses 517, 519. The third apparatus 517 of the decant apparatus is configured to convey one or more containers to and from the first conveyor apparatus 103 of the grid interface assembly and the fourth apparatus 519 is configured to convey one or more container to and from the second conveyor apparatus 104 of the grid interface assembly. Alternatively, the first and second apparatuses 103, 104 of the grid interface assembly can extend to the decant station 515 of the decant apparatus 513 such that one or more containers is conveyed to the decant station by either the first or second conveyor apparatuses and returned from the decant station to the grid interface assembly by either the second or first apparatuses. In the particular example shown in FIG. 14, the separate conveyor system of the decant apparatus are vertically separated into upper and lower conveyor apparatuses. One or more containers are conveyed to and from the decant station by linking together the upper and lower conveyor apparatuses of the decant apparatus by one or more conveyor ramps 520a, 520b.

Movement of the one or more containers to and from the decant station 515 can be shown by the arrows in FIG. 14. Here, the one or more containers are fed to the upper conveyor apparatus 104 of the grid interface assembly by the transfer mechanism and subsequently conveyed to the upper conveyor apparatus of the decant apparatus 519. The one or more containers are conveyed down the conveyor ramp 520a to be presented to an operator 522. At the decant station, one or more items are decanted into the one or more containers. The decanted containers are returned back to the grid interface assembly along the lower conveyor apparatus where it is ultimately transferred back into the frame structure for storage.

In use, empty or partially empty containers fed to the grid interface assembly via its first transfer position 101 is transferred to the first conveyor apparatus 103 where it is subsequently conveyed to the decant station 515 via the third conveyor apparatus 517 for an operator 522 to decant one or more items into the container 2 (herein referred to as a decanted container). Once decanted, the decanted container is returned to the grid interface assembly by conveying the decanted container to the second conveyor apparatus 104 via the fourth conveyor apparatus 519 of the decant apparatus. The reverse is plausible where empty or partially empty containers are fed to the decant station via the second conveyor apparatus and the decanted containers are returned to the grid interface assembly via the first conveyor apparatus. The decant station receives one or more containers from the grid interface assembly and returns the decanted containers to the grid interface assembly using the link 520a, 520b that bridges the third and fourth conveyor apparatuses. The grid interface assembly provides an interface to the grid where one or more containers can be cycled between the frame structure and the decant station.

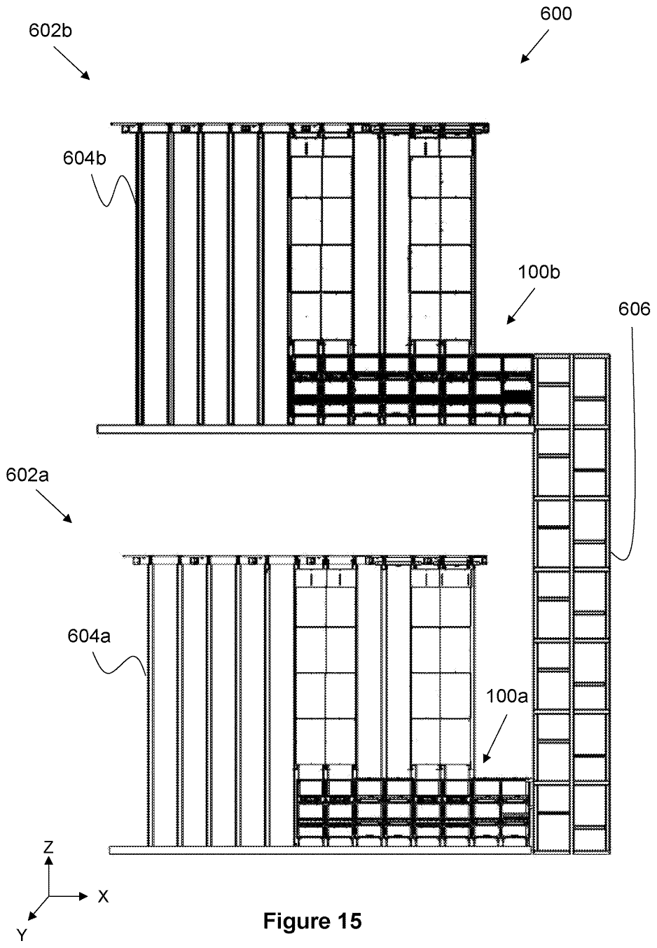

The grid interface assembly can also offer the ability to share storage space between frame structures at remote locations. In congested areas such as populated towns and cities, land space is at a premium. To incorporate a storage and retrieval system in such densely populated areas, the present disclosure provides the ability to share the storage space between two or more frame structures at remote locations. For grocery items that require storage at ambient, chilled and frozen temperatures, multiple storage and retrieval systems are required to automatically store and retrieve the grocery items at the different storage temperatures. In the example shown in FIG. 15, a multi-storey warehouse 600 is shown comprising a first storage and retrieval system 602a at a first location, e.g., ground level, and a second storage and retrieval system 602b at a second location, e.g., first level. Each of the first and second storage and retrieval systems 602a, 602b comprising a respective first and second frame structures 604a, 604b for the storage of a plurality of containers in one or more stacks.

Having multiple storage and retrieval systems that are vertically separated in a multi-storey warehouse not only increases the storage capacity of the warehouse over a given footprint of the warehouse but also enable items to be stored at different temperatures. A transport device 606 transports one or more containers 2 between the first and second storage and retrieval systems 602a, 602b at their respective locations. In the particular example shown in FIG. 15, the transport device 606 is a bin lift or elevator. Examples of bin lift include a raising platform and/or a clamp for gripping the sides of the container and moving the container vertically between the first and second levels. To interface the frame structures of each of the first and second storage and retrieval systems 602a, 602b with the transport device 606, each of the first and second storage and retrieval systems 602a, 602b comprise a grid interface assembly 100a, 100b according to the present disclosure. The grid interface assemblies of each of the first and second grid interface assemblies allow containers to be cycled between the storage space of each of the first and second storage and retrieval systems 602a, 602b.

For ease of explanation, the grid interface assembly of the first storage and retrieval system can be termed a first grid interface assembly 100a and the grid interface assembly of the second storage and retrieval system can be termed a second grid interface assembly 100b. To cycle one or more containers between the first and second grid interface assemblies 100a, 100b, the first and the second conveyor apparatuses of each of the first and second grid interface assemblies interfaces with the transport device 606 such that the first conveyor apparatus of the first grid interface assembly 100a is able to convey the one or more containers to the second conveyor apparatus of the second grid interface assembly 100b and the second conveyor apparatus of the second grid interface assembly 100a is able to convey the one or more containers to the first conveyor apparatus of the first grid interface assembly 100b. Having the first and second grid interface assemblies that respectively interface with the frame structure of the first and second storage and retrieval systems enables storage of a plurality of containers to be shared between remote locations.

For example, in operation, the transfer position of the first grid interface assembly 100a receives a container from the first frame structure 604a and transports the containers laterally to its corresponding first conveyor apparatus, whereupon the first conveyor apparatus conveys the container to the transport device 606. The transport device transports the containers to the second conveyor apparatus of the second grid interface assembly 100b, whereupon the container is transported laterally to the second transfer position to enable a load handling device operable on the grid to pick up the storage container from the second transfer position and store it in the second frame structure at a remote location. Different variations of conveying one or more containers between the first and second conveyor apparatuses of each of the first and second grid interface assemblies 100a, 100b at remote locations are applicable in the present disclosure. For example, the transport device 606 can interface with the first and second conveyor apparatuses of the corresponding first and second grid interface assemblies such that the first conveyor apparatuses of each of the first and second grid interface assemblies convey one or more containers between each other. Likewise, the corresponding second conveyor apparatuses of each of the first and second grid interface assemblies can convey one or more containers between each other.

Having first and second grid interface assemblies 100a, 100b interface with the frame structures 604a, 604b at remote locations provides numerous advantages for conveying one or more containers between the remote locations. In the case of a multi-storey warehouse 600, the frame structures 604a, 604b at the different floor levels can be used to store items at different temperatures, e.g., ambient and chilled temperatures. As grocery items can be stored at ambient and chilled temperatures, the storage space at the different floor levels can be shared.

It will be understood that the above description of is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this invention. By way of example, it will be appreciated that the features described hereinabove may all be used together in a single system. In other embodiments of the invention, some of the features may be omitted. The features may be used in any compatible arrangement.

Further features of the exemplary embodiments of the present disclosure include can include one or more of the following, in any combination:
A. A storage and retrieval system, which may include one or more areas with differing volumes/dimensions, e.g., one area with one number of levels and one or more additional areas having differing respective numbers of levels; some embodiments may include or comprise:
a grid or framework;
a plurality of containers (e.g., totes) located beneath the grid; the plurality of containers may be positioned at different and/or various locations, and there may be one or more containers are different locations; where multiple containers are in a given location, they may be (i) stacked with direct contact between adjacent containers in the stack or nesting, and/or (ii) stacked or position without direct contact, e.g., positioned on shelving or other structure; a grid interface assembly disposed beneath the grid; and
a plurality of load handling devices arranged to move along the grid and configured to move the containers between various positions (e.g., locations and/or stacks) and the grid interface assembly;
wherein the grid interface assembly comprises first transfer positions and second transfer positions at which containers are transferred between the grid interface assembly and the load handling devices, a first conveyor apparatus arranged to convey containers to or from the first transfer positions, and a second conveyor apparatus arranged to convey containers to or from the second transfer positions, the first transfer positions being horizontally separated from the second transfer positions.
B. The storage and retrieval system according to feature A, wherein the first transfer positions and second transfer positions are exposed to the load handling devices operating on the grid.
C. The storage and retrieval system according to any of features A and B, wherein the first conveyor apparatus is disposed below the second conveyor apparatus.
D. The storage and retrieval system according to feature C, wherein the first transfer positions are adjacent to the first conveyor apparatus and the second transfer positions are adjacent to the second conveyor apparatus.
E. The storage and retrieval system according to any of features C and D, and comprising a conveyor assembly providing both the first conveyor apparatus and the second conveyor apparatus, wherein the first transfer positions are disposed on a first side of the conveyor assembly and the second transfer positions are disposed on a second side of the conveyor assembly.
F. The storage and retrieval system according to any of features A to E, wherein the first conveyor apparatus and the second conveyor apparatus are longitudinal and extend out from beneath the grid.
G. The storage and retrieval system according to any of features A to F, wherein the first conveyor apparatus is arranged to convey containers both longitudinally along the first conveyor apparatus and laterally between the first conveyor apparatus and the first transfer positions, and the second conveyor apparatus is arranged to convey containers both longitudinally along the second conveyor apparatus and laterally between the second conveyor apparatus and the second transfer positions.
H. The storage and retrieval system according to any of features A and B, wherein the first transfer positions are adjacent to the first conveyor apparatus and the second transfer positions are above the second conveyor apparatus.
I. The storage and retrieval system according to feature H, and comprising a conveyor assembly providing both the first conveyor apparatus and the second conveyor apparatus, wherein the first transfer positions are disposed adjacent to a side of the conveyor assembly and the second transfer positions are disposed above the conveyor assembly.
J. The storage and retrieval system according to any of features H and I, wherein the first conveyor apparatus and the second conveyor apparatus are longitudinal and extend out from beneath the grid.
K. The storage and retrieval system according to any of features H to J, wherein the first conveyor apparatus is arranged to convey containers both longitudinally along the first conveyor apparatus and laterally between the first conveyor apparatus and the first transfer positions, and the second conveyor apparatus is arranged to convey containers both longitudinally along the second conveyor apparatus and vertically between the second conveyor apparatus and the second transfer positions.
L. The storage and retrieval system according to any of features A and B, wherein the first conveyor apparatus is adjacent to the second conveyor apparatus.
M. The storage and retrieval system according to feature L, wherein the first transfer positions are adjacent to the first conveyor apparatus and the second transfer positions are adjacent to the second conveyor apparatus.
N. The storage and retrieval system according to any of features L and M, and comprising a conveyor assembly providing both the first conveyor apparatus and the second conveyor apparatus, wherein the first transfer positions are disposed on a first side of the conveyor assembly and the second transfer positions are disposed on a second side of the conveyor assembly.
O. The storage and retrieval system according to any of features L to N, wherein the first conveyor apparatus and the second conveyor apparatus are longitudinal and extend out from beneath the grid.
P. The storage and retrieval system according to any of features L to O, wherein the first conveyor apparatus is arranged to convey containers both longitudinally along the first conveyor apparatus and laterally between the first conveyor apparatus and the first transfer positions, and the second conveyor apparatus is arranged to convey containers both longitudinally along the second conveyor apparatus and laterally between the second conveyor apparatus and the second transfer positions.
Q. The storage and retrieval system according to feature L, wherein the first transfer positions comprise a first subset that are adjacent to the first conveyor apparatus and a second subset that are above the first conveyor apparatus, and the second transfer positions comprise a first subset that are adjacent to the second conveyor apparatus and a second subset that are above the second conveyor apparatus.
R. The storage and retrieval system according to feature Q, and comprising a conveyor assembly providing both the first conveyor apparatus and the second conveyor apparatus, wherein the first subset of the first transfer positions are disposed on a first side of the conveyor assembly and the first subset of the second transfer positions are disposed on a second side of the conveyor assembly.
S. The storage and retrieval system according to any of features Q and R, wherein the first conveyor apparatus and the second conveyor apparatus are longitudinal and extend out from beneath the grid.
T. The storage and retrieval system according to any of claims Q to S, wherein:
the first conveyor apparatus is arranged to convey containers both longitudinally along the first conveyor apparatus, laterally between the first conveyor apparatus and the first subset of the first transfer positions, and vertically between the first conveyor apparatus and the second subset of the first transfer positions; and
the second conveyor apparatus is arranged to convey containers both longitudinally along the second conveyor apparatus, laterally between the second conveyor apparatus and the first subset of the second transfer positions, and vertically between the second conveyor apparatus and the second subset of the second transfer positions.
U. The storage and retrieval system according to any of features Q to T, wherein:
the first subset of the first transfer positions and the second subset of the first transfer positions are alternately distributed along the first conveyor apparatus; and
the first subset of the second transfer positions and the second subset of the second transfer positions are alternately distributed along the second conveyor apparatus.
V. A method of operating a storage and retrieval system comprising a grid, a plurality of containers located in stacks beneath the grid, a grid interface assembly disposed beneath the grid, and a plurality of load handling devices arranged to move along the grid and configured to move the containers between the stacks and grid interface assembly, the method comprising:
using a first conveyor apparatus of the grid interface assembly to convey containers to or from first transfer positions of the grid interface assembly, and using a second conveyor apparatus of the grid interface assembly to convey containers to or from second first transfer positions of the grid interface assembly, the first transfer positions being horizontally separated from the second transfer positions; and
transferring containers between the first transfer positions of the grid interface assembly and the load handling devices, and transferring containers between the second transfer positions of the grid interface assembly and the load handling devices.
W. The method according to feature V, wherein containers are conveyed in a first direction by the first conveyor apparatus and containers are conveyed in a second direction by, the first direction being one of to the grid and away from the grid and the second direction being the other of to the grid and away from grid.
X. The method according to feature V, wherein containers are conveyed in a direction by the first conveyor apparatus and the second conveyor apparatus, the direction being any of to the grid and away from the grid.

What is claimed is:

1. A grid interface assembly for receiving one or more containers from a storage and retrieval system comprising a grid, a plurality of containers located in stacks beneath the grid; and
a plurality of load handling devices operable to move along the grid and configured to retrieve the one or more containers from the stacks, the grid interface assembly comprises:
i) a transfer position for receiving one or more containers from the one or more of the plurality of load handling devices operable on the grid,
ii) a conveyor apparatus for conveying the one or more containers beneath the grid, the transfer position being laterally disposed from the conveyor apparatus; and
iii) a transfer mechanism configured to convey containers between the transfer position and the conveyor apparatus.

2. The grid interface assembly according to claim 1, wherein the transfer mechanism comprises a transfer belt, the transfer belt extends continuously between the transfer position and the conveyor apparatus.

3. The grid interface assembly according to claim 2, further comprising a lifting device for raising and lowering a conveyor section of the conveyor apparatus and the transfer belt relative to each other so as to expose the transfer belt above the top of the conveyor section such that, in use, the transfer belt contacts the container and to retract the transfer belt below the top of the conveyor section such that, in use, the container contacts the top of the conveyor section.

4. The grid interface assembly according to claim 3, wherein the lifting device is configured for raising and lowering the conveyor section of the conveyor apparatus relative to the transfer belt between a lowered position to expose the transfer belt above the top of the conveyor section such that, in use, the transfer belt contacts the container and a raised position to retract the transfer belt below the top of the conveyor section such that, in use, the container contacts the top of the conveyor section.

5. The grid interface assembly according to claim 4, further comprising a control system comprising one or more processors and memory storing instructions that when executed by the one or more processors cause the one or more processors to operate the lifting device to:
i) lower the conveyor section to the lowered position for transferring one or more containers between the transfer position and the conveyor apparatus; and
ii) raise the conveyor section to the raised position for conveying one or more containers along the conveyor apparatus in a direction substantially perpendicular to the transport direction of the transfer mechanism.

6. The grid interface assembly according to claim 1:
wherein the transfer position a comprises a first transfer position and a second transfer position;
wherein the conveyor apparatus comprises a first conveyor apparatus arranged to convey containers longitudinally along the first conveyor apparatus and a second conveyor apparatus arranged to convey containers longitudinally along the second conveyor apparatus; and
wherein the transfer mechanism comprises a first transfer mechanism and a second transfer mechanism, the first transfer mechanism being configured to convey containers laterally between the first transfer position and the first conveyor apparatus and the second transfer mechanisms laterally being configured to convey containers between the second transfer position and the second conveyor apparatus.

7. The grid interface assembly according to claim 6, wherein the first conveyor apparatus is vertically separated from the second conveyor apparatus.

8. The grid interface assembly according to claim 6, wherein the first transfer position is adjacent to the first conveyor apparatus and the second transfer positions are above the second conveyor apparatus.

9. The grid interface assembly according to claims 6, wherein the first conveyor apparatus is adjacent to the second conveyor apparatus.

10. The grid interface assembly according to claim 9, wherein the first transfer position comprise a first subset that are adjacent to the first conveyor apparatus and a second subset that are above the first conveyor apparatus such that the first transfer mechanism is arranged to convey containers laterally between the first conveyor apparatus and the first subset of the first transfer position, and the second transfer positions comprise a first subset that are adjacent to the second conveyor apparatus and a second subset that are above the second conveyor apparatus such that the second transfer mechanism is arranged to convey containers laterally between the second conveyor apparatus and the first subset of the second transfer positions.

11. A storage and retrieval system comprising:
a grid;
a plurality of containers located in stacks beneath the grid;
a grid interface assembly according to claim 1 disposed beneath the grid; and
a plurality of load handling devices arranged to move along the grid and configured to move the containers between the stacks and grid interface assembly.

12. The storage and retrieval system according to claim 11, wherein the transfer position is exposed to the load handling devices operating on the grid.

13. The storage and retrieval system according to claim 11, wherein the conveyor apparatus is longitudinal and extend out from beneath the grid.

14. A storage and retrieval system comprising:
a grid;
a plurality of containers located in stacks beneath the grid;
a grid interface assembly according to claim 6 disposed beneath the grid; and
a plurality of load handling devices arranged to move along the grid and configured to move the containers between the stacks and the grid interface assembly,
wherein the first and second conveyor apparatuses are longitudinal and extend out from beneath the grid; and the first transfer position is configured to receive one or more containers from one or more of the plurality of load handling devices operable on the grid and the one or more of the plurality of load handling devices operable on the grid is configured to pick up one or more containers from the second transfer position.

15. The storage and retrieval system of claim 14, further comprising an inventory handling apparatus comprising an inventory handling station for handling one or more containers of the plurality of containers, wherein the first conveyor apparatus is configured to convey the one or more containers of the plurality of containers to the inventory handling station and the second conveyor apparatus is configured to return the one or more containers of the plurality of containers from the inventory handling station.

16. The storage and retrieval system of claim 15, wherein the inventory handling apparatus is a decant apparatus and the inventory handling station is a decant station for decanting one or more items into the one or more containers of the plurality of containers.

17. A warehouse comprising:
i) a first storage and retrieval system at a first location and a second storage and retrieval system at a second location, the second location being remote from the first location, each of the first and second storage and retrieval systems comprising a storage and retrieval system as defined in claim 14,
iii) a transport device for transporting one or more containers between the first location and the second location;
wherein the corresponding grid interface assemblies of each of the first and second storage and retrieval systems is configured to convey one or more containers of the plurality of containers to or from the transport device such that the one or more containers is transported between the corresponding grid interface assembly of the first and the second storage and retrieval systems at their respective first and second locations.

18. The warehouse of claim 17, wherein the first location is vertically separate from the second location to define a multi-storey warehouse, and wherein the transport device is a lifting device for transporting the one or more containers between the first and second locations.

19. A method of decanting one or more items into a container by the storage and retrieval system of claim 16, the method comprising the steps of:
i) receiving the container at the first transfer position and transferring the container to the first conveyor apparatus;
ii) conveying the container to the decant station;
iii) decanting the one or more items into the container at the decant station;
iv) conveying the decanted container to the second conveyor apparatus and transferring the decanted container to the second transfer position; and
v) instructing a loading handing device operable on the grid to pick up the decanted container from the second transfer position.

20. A method of conveying a container between different locations of a warehouse of claim 17, the method comprising the steps of:
i) receiving the container at the corresponding first transfer position of the first and retrieval system at the first location and transferring the container to the corresponding first conveyor apparatus of the first storage and retrieval system;
ii) conveying the container by the first conveyor apparatus of the first storage and retrieval system to the transport device;
iii) transporting the container from the first location to the second location by the transport device;
iv) conveying the container to the corresponding second conveyor apparatus of the second storage and retrieval system and transferring the container to the corresponding second transfer position of the second storage and retrieval system; and
v) instructing a loading handing device operable on the grid of the second storage and retrieval system to pick up the container from the corresponding second transfer position.
